(19) United States
(12) Patent Application Publication
(10) Pub. No.: US 2025/0319793 A1
(43) Pub. Date: Oct. 16, 2025

(54) REMOTE STORAGE AND IMPLEMENTATION OF GRID CODES FOR CONTROLLING CHARGING/DISCHARGING AN ELECTRIC VEHICLE

(71) Applicant: Volvo Car Corporation, Gothenburg (SE)

(72) Inventors: Vijay Arumugam, Gothenburg (SE); Mohammad Ali Fotouhi Ghazvini, Kungsbacka (SE); Niklas Smith, Goteborg (SE); Sourav Shah, Landvetter (SE)

(21) Appl. No.: 18/635,348

(22) Filed: Apr. 15, 2024

(51) Int. Cl. B60L 55/00; B60L 53/68

(52) U.S. Cl. CPC B60L 55/00; B60L 53/68; B60L 2240/622; B60L 2240/70

(57) ABSTRACT

Operation of an electric vehicle (EV) is monitored and controlled to enable operation in a vehicle to grid (V2G) configuration. During bidirectional power transfer, energy stored in batteries onboard the electric vehicle can be transferred to the grid. During a period of high energy input into the grid, e.g., energy sourced from wind turbines/solar, the energy can be stored in the onboard batteries. During low energy input, the energy stored in the batteries can be transferred to the grid. V2G operation is conducted in accordance with a grid code(s) implemented at the grid. Grid codes can be forwarded from respective grid operators to a central system (remotely located from the EV), and subsequently forwarded for implementation to the EV. Based on EV location, the central system can control which grid code is forwarded to the EV and also whether the EV can perform V2G operation(s).

### TECHNICAL FIELD

This application relates to techniques facilitating charging and/or discharging power/energy at an electric vehicle.

### BACKGROUND

Electric vehicles are powered by an electric motor that draws energy from an onboard battery. The battery can be recharged at any time, e.g., while parked for a duration of time, such as overnight at a residence, at a service station, and suchlike. The charging operation typically entails connection of the electric vehicle to a charging station via a charging cable plugged into a charging port on the vehicle.

Conventionally, when an electric vehicle is connected to the electrical grid/network, via a charging station, the electric vehicle undergoes charging. However, implementation of ISO 15118 includes specifications for the electric vehicle to act as the power source/generator, and accordingly, transmit energy from the electric vehicle to the grid. Renewable energy resources such as wind turbines, solar, etc., are configured to generate energy, but the energy generation can be weather/situation dependent, e.g., no wind, cloudy/night time, and suchlike. Electric vehicle batteries can be connected to the grid and utilized to store energy during production of excessive renewable energy, and provide the energy to the grid at times when the grid can accommodate/use the energy.

Power plants, wind turbines, solar panels, etc., are regulated with regard to how the respective systems/devices can be connected to the grid, e.g., via location-specific specifications, regulations, grid codes, etc. Electric vehicles operating as power generators are also required to comply with such regulations, grid codes, and suchlike, implemented at the location of the electric vehicle connected to the grid. However, implementation of the electric vehicle as a generator can be complicated as operation of the electric vehicle is inherently mobile and respective grid codes/specifications that the electric vehicle has to comply with can change depending on a location of the electric vehicle when the electric vehicle is to operate as a power source/generator.

### SUMMARY

The following presents a summary to provide a basic understanding of one or more embodiments described herein. This summary is not intended to identify key or critical elements, or delineate any scope of the different embodiments and/or any scope of the claims. The sole purpose of the Summary is to present some concepts in a simplified form as a prelude to the more detailed description presented herein.

The various embodiments presented herein relate to facilitating vehicle to grid (V2G) operation of an electric vehicle (EV), whereby energy stored in a battery located onboard the EV can be transferred to an electric grid connected to the EV. The energy in the battery is discharged from the EV to the grid. Implementation of the grid codes on the EV, and also operation of the EV can be controlled based on grid codes and instructions provided by a remotely located system.

According to one or more embodiments, a system is presented which can comprise a memory that stores computer executable components and a processor that executes the computer executable components stored in the memory. The system can be located onboard an electric vehicle (EV). The computer executable components can comprise a control component configured to: receive an instruction indicating whether a vehicle to grid (V2G) operation can be performed at the EV, wherein the EV has an initial operating condition of V2G operation is disabled, the instruction is received from an external system remotely located to the EV. In a further embodiment, the control component can be configured to process the instruction to determine whether the instruction enables or disables V2G operation, and in the event of determining the instruction indicates that V2G operation is enabled, the control component can be further configured to enable the EV to function as a power source for an energy grid.

In another embodiment, the control component can be further configured to, in response to determining the instruction does not enable V2G operation, maintain the operating condition as V2G disabled, thereby preventing the EV to function as a power source for the energy grid.

In another embodiment, the system can further comprise one or more onboard batteries located on the EV, wherein the one or more onboard batteries are configured to function as the power source for the energy grid.

In another embodiment, the system can further comprise a location component, configured to: determine a current location of the EV.

In a further embodiment, the location component can be further configured to determine the current location of the EV based on at least one of global positioning system (GPS) location data or location information provided by electric vehicle supply equipment (EVSE) to which the EV is connected to enable connection of the EV to the energy grid.

In another embodiment, the instruction can further include a first grid code to be implemented at the current location by the EV during the V2G operation.

In another embodiment, the system can further comprise an onboard charger connected to one or more batteries located on the EV, wherein the control component can be further configured to: generate a second grid code, wherein the second grid code is a copy of the first grid code; and implement the second grid code on the onboard charger to facilitate operation of the one or more batteries in accordance with an operational requirement of the energy grid.

In another embodiment, prior to implementation of the second grid code on the onboard charger, the control component is further configured to: confirm the first grid code received from the external system matches the second grid code to be implemented at the onboard charger; and in response to a determination that the second grid code does not match the first grid code, the control component is further configured to cancel implementation of the second grid code on the onboard charger.

In a further embodiment, the first grid code can comply with at least one of a specification or regulation implemented at the grid to ensure safe operation of the energy grid.

In another embodiment, the external system can be one of a centralized system controlling at least one operation of the EV, a cloud-based system controlling at least one operation of the EV, or a remote system operated by an original equipment manufacturer (OEM) of the EV.

In other embodiments, elements described in connection with the disclosed systems can be embodied in different forms such as computer-implemented methods, computer program products, or other forms. For example, in an embodiment, a computer-implemented method can be performed by a device operatively coupled to a processor. In an embodiment, the computer-implemented method can comprise: receiving, by an onboard device comprising a processor, an instruction indicating whether a vehicle to grid (V2G) operation can be performed at the EV, wherein the EV has an initial operating condition of V2G operation is disabled, the instruction is received from an external system remotely located to the EV; and in response to determining the instruction enables V2G operation, adjusting, by the onboard device, the operating condition to V2G is enabled, thereby enabling the EV to function as a power source for an energy grid.

In an embodiment, the computer-implemented method can further comprise, in response to determining the instruction does not enable V2G operation, maintaining, by the onboard device, the operating condition as V2G disabled, thereby preventing the EV to function as a power source for the energy grid.

In an embodiment, the computer-implemented method can further comprise: identifying, by the onboard device, a location of the EV; transmitting, by the onboard device, the location of the EV to the remotely located system; receiving, by the onboard device, a grid code configured for the location of the EV, wherein the grid code is received from the remotely located system; and implementing, by the onboard device, the grid code to control V2G operation of the EV.

In another embodiment, the computer-implemented method can further comprise: receiving, by the onboard device, an adjustment to the grid code, wherein the adjustment is applied at the EV, transmitting, by the onboard device, the adjustment to the remotely located system, further receiving, by the onboard device, an instruction from the remotely located system, further determining, by the onboard device, whether the instruction denies implementation of the adjustment to the grid code, and in response to determining the instruction denies implementation of the adjustment to the grid code, preventing, by the onboard device, adjustment of the grid code.

In another embodiment, the external system can be one of a centralized system controlling at least one operation of the EV, a cloud-based system controlling at least one operation of the EV, or a remote system operated by an original equipment manufacturer (OEM) of the EV.

In another embodiment, wherein the EV is located at a first location, the computer-implemented method can further comprise: (a) terminating, by the onboard device, V2G operation of the EV at the first location; (b) identifying, by the onboard device, a second location of the EV; (c) transmitting, by the onboard device, the second location of the EV to the remotely located system; (d) receiving, by the onboard device, a second grid code configured for the second location of the EV, wherein the second grid code is received from the remotely located system; and (e) implementing, by the onboard device, the second grid code to control V2G operation of the EV at the second location.

Further embodiments can include a computer program product comprising a computer readable storage medium having program instructions embodied therewith. The program instructions are executable by a processor, and can cause the processor to receive an instruction indicating whether a vehicle to grid (V2G) operation can be performed at the EV, wherein the EV has an initial operating condition of V2G operation is disabled, the instruction is received from an external system remotely located to the EV, and in response to determining the instruction enables V2G operation, adjust the operating condition to V2G is enabled, thereby enabling the EV to function as a power source for an energy grid.

In another embodiment, the program instructions are further executable by the processor to cause the processor to identify a location of the EV, transmit the location of the EV to the remotely located system, further receive, from the remotely located system, a grid code configured for the location of the EV, and further implement the grid code to control V2G operation of the EV.

In another embodiment, with the EV located at a first location, the program instructions are further executable by the processor to cause the processor to (a) terminate V2G operation of the EV at the first location, (b) identify a second location of the EV, (c) transmit the second location of the EV to the remotely located system, (d) receive a second grid code configured for the second location of the EV, wherein the second grid code is received from the remotely located system, and (e) implement the second grid code to control V2G operation of the EV at the second location.

In another embodiment, the external system is one of a centralized system controlling at least one operation of the EV, a cloud-based system controlling at least one operation of the EV, or a remote system operated by an original equipment manufacturer (OEM) of the EV.

### DESCRIPTION OF THE DRAWINGS

One or more embodiments are described below in the Detailed Description section with reference to the following drawings.

FIG. 1A presents a system configured for, and illustrating, high level operation of a vehicle functioning as an energy source for an electric energy grid, devices, etc., in accordance with one or more embodiments.

FIG. 1B presents a further detailed view of a system configured for operation of a vehicle functioning as an energy source for an electric energy grid, devices, etc., in accordance with one or more embodiments.

FIG. 2 illustrates a flow diagram for a computer-implemented process to enable an electric vehicle to function as a generator on an electrical energy grid in accordance with respective specifications/regulations/grid codes required for connection/energy provision to a local grid, in accordance with at least one embodiment.

FIG. 3 presents a flow diagram for a computer-implemented process enabling identification and updating of grid codes based on location of an EV in a V2G operation, in accordance with one or more embodiments.

FIG. 4 presents a flow diagram for a computer-implemented process for resolving conflict of operation between a 3^{rd} party setpoint and a LFSM requirement, in accordance with an embodiment.

FIG. 5 presents a system configured to maintain charging of an EV in the event of temporary disconnection, in accordance with an embodiment.

FIG. 6A presents a flow diagram of a computer-implemented process to re-commence charging/discharging operations at an EV after a temporary disconnection from a grid, in accordance with an embodiment.

FIG. 6B presents a flow diagram of a computer-implemented method to re-commence charging/discharging operations at an EV after a temporary disconnection from a grid, in accordance with an embodiment.

FIG. 7A presents a map providing an example of different regions to implement grid codes for Denmark.

FIG. 7B illustrates a boundary box approach to demarcate respective regions of implementation of respective grid codes and specifications, in accordance with one or more embodiments.

FIG. 8 illustrates a computer-implemented method to apply/implement more than one grid code/specification in a geographic region, in accordance with an embodiment.

FIG. 9 presents a computer-implemented method to control V2G operation of an EV based upon grid code availability, in accordance with an embodiment.

FIG. 10 presents a flow diagram of a computer-implemented method for controlling, by an external system, V2G operation(s) at an EV, in accordance with at least one embodiment.

FIG. 11, flowchart 1100 presents a computer-implemented method for confirming and implementing a user change to a grid code, in accordance with at least one embodiment.

FIG. 12 is a block diagram illustrating an example computing environment with which the disclosed subject matter can interact, in accordance with an embodiment.

FIG. 13 is a block diagram illustrating an example computing environment with which the disclosed subject matter can interact, in accordance with an embodiment.

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, in the Detailed Description section, and/or the Abstract.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting. As used herein, “data” can comprise metadata. Further, ranges A-n are utilized herein to indicate a respective plurality of devices, components, signals etc., where n is any positive integer. Furthermore, x herein indicates any value greater than zero.

### Terminology

BACKEND SYSTEM: a centralized system in communication with any of an EV, an EVSE, DSO, operator of a power grid, chargepoint operator, and suchlike. In an embodiment, the backend system can authorize/approve implementation of respective grid codes/parameters/specification for a grid/DSO at a location for V2G operation by the EV. The backend system can be configured to receive grid codes/parameters/specifications from a grid/DSO and forward the grid codes/parameters/specifications to the EV. The backend system can control/authorize whether an EV can perform V2G operation(s) at a current location/EVSE. The backend system can be a “cloud-based” system. The backend system can be operated by a third/3rd party authorized by the owner of the EV, by an original equipment manufacturer (OEM) of the EV, by a fleet car owner, rental vehicle owner, and suchlike.
BEV: Battery electric vehicle.
BPT: Bidirectional Power Transfer, e.g., grid to EV, EV to grid, and suchlike.
DER: Distributed energy resource is a small-scale unit of power generation that operates locally and is connected to a larger power grid at the distribution level. DERs can include electric vehicles, solar panels, etc.
DSO: Distribution system operators are companies distributing electricity for a given region of operation. A first DSO, operating across a first region, can enable access (e.g., via a first billable account) to an energy grid, while a second DSO, operating at a second region, can enable access (e.g., via a second billable account) to the same energy grid. For example, more than one thousand DSOs are operating in Europe and able to feed-in energy back to the electricity grid in their operating area. An electric vehicle operating as a generator should be certified/in compliance with any grid codes/specifications applicable to a region and also requires approval of the DSO providing grid access in the region. Entities DSO and TSO are used interchangeably herein.
EV: Electric vehicle.
EVSE: Electric Vehicle Supply Equipment comprising conductors, including the phase(s), neutral and protective earth conductors, the EV couplers, attached plugs, and all other accessories, devices, power outlets or apparatuses installed specifically for the purpose of transmitting energy at a location/premises between an EV and a grid, and further enabling communication/data transmission between an EV, the grid, a DSO, a backend system, and suchlike, as required during BPT operation.
GRID CODE: a grid code is a technical specification defining one or more operation conditions/parameters which a system (e.g., an EV) connected to a power grid (e.g., a public electric grid) has to meet to ensure safe, secure, and economic functioning of the grid, infrastructure, and/or the connected system. The system can be an electricity generating plant, an EV functioning as a power source/generator, a consumer, or another network. The grid code is specified by an authority responsible for the system integrity and network operation (e.g., an operator of the grid, DSO, TSO). Elaboration of a grid code usually involves network operators (DSOs, TSOs), representatives of users and, to an extent varying between countries, the regulating body.
IEC: International Electrotechnical Commission (Commission élecrotechnique internationale) is a Swiss-based international standards organization for electrotechnology, electrical, electronic, and related technologies.
ISO: International Organization for Standardization, a Swiss-based organization developing standards for multiple industries, food safety, healthcare, and suchlike.
OBSERVATION TIME: during initial stages of interaction and communication between an EV, an EVSE, and the grid, as part of a BPT operation with an EV functioning as an energy source for the grid, an observation time is required to be met/elapse before the EV can perform the power transfer (e.g., as defined in EN 50549-1), with communications between the EV and the EVSE being specified by, for example, ISO 15118. During the observation time period, the EV, the EVSE, and the grid can perform such functions as exchanging respective technical information/parameters/data/limits regarding BPT (charging/discharging) such as confirming that respective operating conditions (e.g., frequency, voltage, power gradient, impedance, and suchlike) are as required for energy transfer between the EV, the EVSE, and the grid without damaging, for example, a battery onboard the EV or infrastructure/components of the grid. The observation time period can be utilized to ensure the grid is not experiencing a grid emergency, for example.
PHEV: plug-in hybrid electric vehicle.
3rd PARTY SETPOINT: a parameter/setting/adjustment to a grid code, specification, regulation, and suchlike. Can be provided by any entity associated with the EV, EVSE, grid, etc., including, in a non-limiting list: a DSO, chargepoint operator, entity associated with a backend system, OEM, home energy management system, energy aggregator, energy flexibility provider, representative of the EV owner/operator, and suchlike.
TSO: Transmission system operator is an entity entrusted with transporting electrical power over a grid between a power generation source to a local distribution point (e.g., an EVSE), and in the case of BPT, from the local distribution point (e.g., to which the EV is connected) to the power generation source. TSO's are also known as an independent system operator (ISO), a regional transmission organization (RTO), and suchlike.
VDE: (Verband der Elektrotechnik, Elektronik und Informationstechnik, the Association for Electrical, Electronic & Information Technologies) is a German-based technical-specification association concerned with developing electrical safety standards. VDE conduct standardization work, product testing, and product certification.

### Standards/Specifications/Regulations

It is to be appreciated that while the following presents respective specifications/regulations directed towards energy transfer during BPT operation of an EV connected to a grid, the various embodiments are not so limited and the various embodiments presented herein can be utilized with any pertinent specification/regulation/grid code.

### A. ISO 15118

ISO 15118 Road Vehicles is a specification regarding communication(s) between an EV and an EVSE. Under ISO 15118, EVs include BEVs and PHEVs. ISO 15118 details communication between an electric vehicle communication controller (EVCC) (e.g., located on the EV) and a supply equipment communication controller (SECC) (e.g., located on the EVSE), and equipment at the grid/DSO. Communications between an EV, EVSE, DSO, etc., enable one or more specifications, regulations, grid codes, etc., (and associated parameters, e.g., power limits, power values, chargeloop settings, and suchlike), to be identified/shared for a particular location of the EV, e.g., as part of a V2G operation.

### B. VDE-AR-n 4105

Specification VDE-AR-n 4105 pertains to power generation systems connected to the low-voltage distribution network/grid, and in particular, provides technical minimum requirements for the connection to and parallel operation with low-voltage distribution networks.

### C. EN 50549-1

Specification EN50549-1 details requirements for electrical generating plants to be connected in parallel with electrical distribution networks/grids. Further, Part 1 relates to connection to a Low Voltage (LV) distribution network, in particular, electrical generating plants up to and including Type 13. For compliance with EN 50549-1, the respective systems presented herein can include any necessary equipment/components/devices, for example, hardware may be required comprising a digital input/interface with the EVSE (e.g., in a wallbox proximate to the EVSE 120), whereby the digital input can be a hardware digital input and/or an input directly received from a backend system, and suchlike. The digital interface can be provided between the EV and the grid (e.g., operated by the DSO), such that discharging instructions, and suchlike, can be received at the EVSE to enable V2G operation of the EV to be in compliance with EN 50549 grid requirement, e.g., enabling EV to certify as a generator under EN 50549.

### D. ISO 3166-1 & 3166-2

ISO 3166-1 and ISO 3166-2 can be utilized to identify a location of an EV, an EVSE, and/or an energy grid, wherein the location can be based on the codes identifying respective countries, regions, subregions, subdivisions (e.g., provinces or states), etc., wherein ISO 3166-2 is known as Codes for the representation of names of countries and their subdivisions Part 2: Country subdivision code. In an aspect, global positioning system (GPS) coordinates/information regarding location of an EV, an EVSE, energy grid, etc., can be utilized to determine respective location under ISO 3166-1 and 3166-2.

### E. IEC 61851-1

IEC 61851 is a standard pertaining to electric vehicle conductive charging systems. IEC 61851 pertains to hardware requirements regarding connection of an EV (e.g., EV 110) to an EVSE (e.g., EVSE 120), whereby IEC 61851 can be extended to comply with respective grid codes/requirements for the EV to operate as a generator, e.g., limiting an active discharge power based on a received setpoint (e.g., in a signal received from a DSO), digital I/O or cloud backend to receive signals from a DSO, etc.

### Bidirectional Power Transfer and ISO 15118

The ISO 15118 standard includes a Bidirectional Power Transfer (BPT) feature, whereby an EV can receive energy from the grid via an EVSE but can also act as an energy source/generator feeding energy back into the grid via the EVSE.

Per the various embodiments presented herein, the disclosed subject matter can be directed to various operations, communications, functions, and suchlike, performed by respective devices, components, computer systems, equipment, etc., to safely transmit power between power sources/generators and power users, in accordance with respective regulations, specifications, grid codes, and suchlike. The various embodiments presented herein are further directed towards operation of an EV navigating respective regions and performing BPT in accordance with grid codes, regulations, etc., implemented in a given region, wherein a first grid code implemented in a first region is disparate to a second grid code implemented in a second region.

While one or more devices and/or systems are described below with reference to an electric vehicle, such as an automobile, the one or more embodiments described herein are not limited to this use. One or more embodiments presented herein can be utilized to monitor/control BPT with any vehicle having an onboard battery, wherein the battery may be located on a military vehicle, railroad vehicle, a marine vehicle such as a boat, ship, submarine, or marine drone, a winged vehicle such as a plane or drone, and/or a rotored vehicle such as a helicopter or drone. Likewise, one or more embodiments presented herein can be extended to monitoring/controlling BPT at a robot and/or any suitable moving or stationary device. Other applicable applications include scooters, Segway®, electric bicycles, E-rickshaws, and the like.

Further, the embodiments can be applied to any vehicle utilizing a battery system, e.g., a Battery Electric Vehicle (BEV) where the powerplant is only an electric motor powered by a battery and the battery is recharged via an external charging station, a Hybrid Electric Vehicle (HEV) having both a gasoline/petrol engine & fuel tank and an electric motor powered by a battery, wherein operation of the HEV recharges the battery (e.g., via a regenerative braking system capturing kinetic energy), a Plug-in Hybrid Electric Vehicle (PHEV) having both a gasoline/petrol engine & fuel tank and an electric motor powered by a battery, wherein the battery can be charged via an external charging station, and the like.

The various embodiments and concepts can be directed to any device utilizing battery power technology, such as battery cells comprising lithium-ion (Li-ion) battery technologies, lithium nickel cobalt Aluminum (NCA), lithium-nickel manganese cobalt (NMC), lithium-manganese spinel (LMO), lithium titanate (LTO), lithium-iron phosphate (LFP), lithium metal polymer (LMP), nickel manganese cobalt (NMC), nickel-metal hydride (Ni-MH), lithium sulphur (Li—S), lead-acid batteries, as well as ultracapacitors, super capacitors, chemical batteries, solid-state batteries, fuel cells, etc.

### 1. Overview of Systems for EV BPT Operation

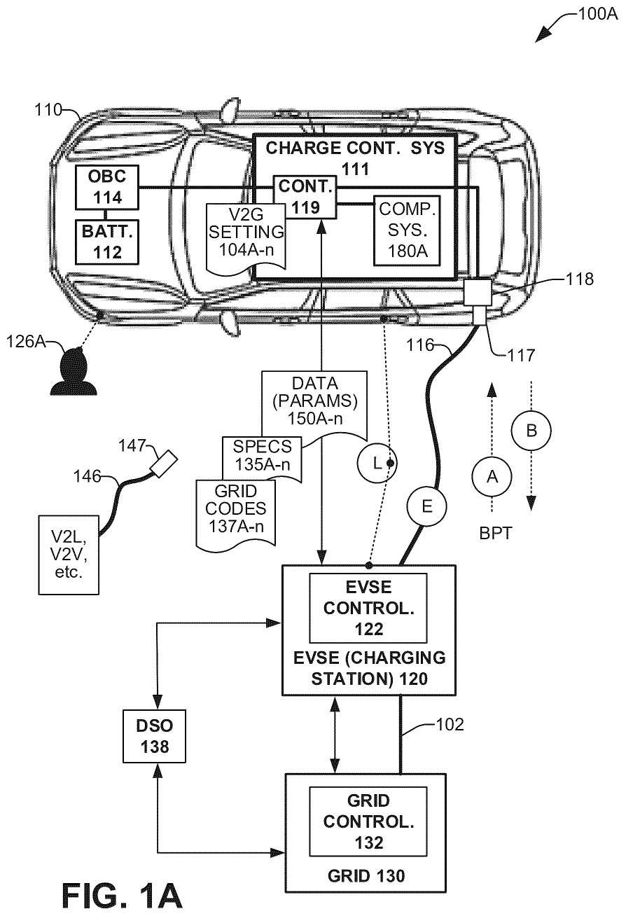

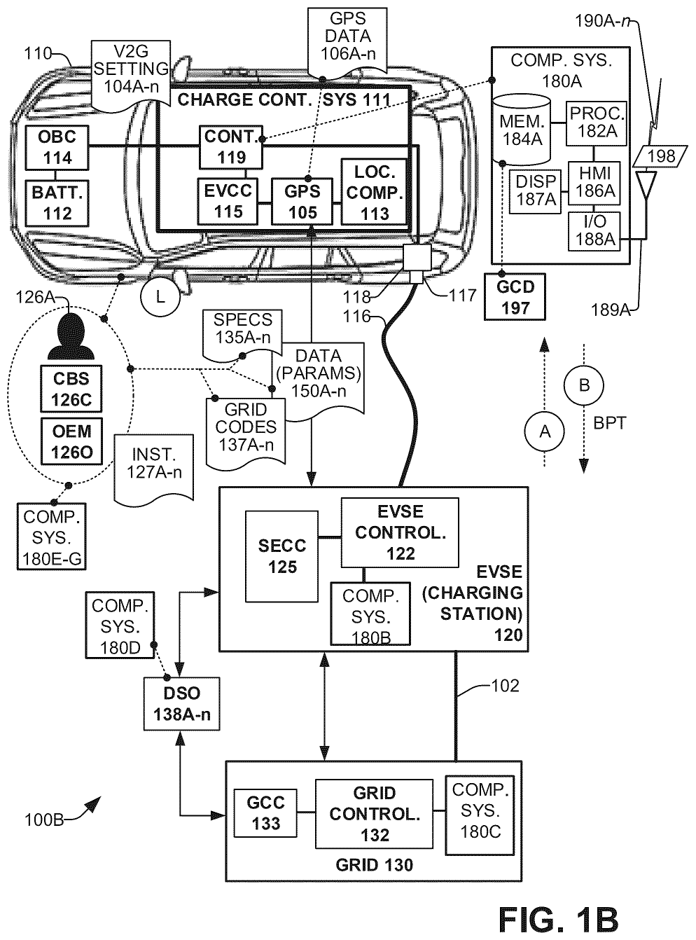

FIG. 1A, system 100A illustrates high level operation of a vehicle functioning as an energy source for an electric energy grid, devices, etc., in accordance with one or more embodiments.

As shown in FIG. 1A, an EV 110 (at location L) can be connected to EVSE 120, wherein the EVSE 120 can be a charging station, or suchlike. Transmission of electrical energy E between the EV 110 and the EVSE 120 can be via a charging cable 116 and connection plug 117 inserted in socket 118 onboard EV 110. Plug 117 can be configured based on J1772, Combined Charging System (CCS), SAE Combo, Charge de Move (CHAdeMO), TESLA®, and suchlike. As further described, one or more communications or operational configurations can be performed (e.g., by EV 110 and the EVSE 120) during coupling of the charging cable 116 to EVSE 120.

EVSE 120 is further connected to electrical energy grid, grid 130, e.g., via power line(s) 102, wherein EVSE 120 can function as an intermediary between the EV 110 and the grid 130. Batteries 112A-n are located at/onboard EV 110, wherein batteries 112A-n can provision power to other devices and systems co-located onboard EV 110, such as an electric motor, lighting, air conditioning (not shown), etc., as well as provisioning power to devices located external to EV 110, and further provision power to the grid 130.

As previously mentioned, with implementation of standard ISO 15118 (per specification 135A-n), BPT can be conducted between EV 110 and EVSE 120, e.g., EV 110 can function as a power source/generator, and accordingly, transfer energy E from EV 110 to grid 130 (also known as vehicle-to-grid, vehicle2grid, V2G). Conventionally, charging of EV 110 would be conducted via flow of energy E along charging cable 116 in direction A, whereby batteries 112A-n located at/onboard EV 110 undergo charging. With the implementation of BPT, EV 110 can function as the energy generator/energy source, with flow of energy E occurring via charging cable 116 in direction B.

While EV 110 can be connected to grid 130, EV 110 can also function as a power source for other externally-located systems, equipment, devices, etc. For example, EV 110 can be electrically coupled to another vehicle (aka vehicle to vehicle, V2V), EV 110 to local grid (aka vehicle to local, V2Local), and EV 110 to land (aka vehicle to land, V2L). In an example operating scenario, V2L relates to a configuration where a device, such as a laptop, is connected to an alternating current (AC) outlet (not shown) at EV 110. Any of V2V, V2Local, V2L, etc., can be conducted via a second charging cable, charging cable 146 and connector 147, connecting EV 110 to the other vehicle, device, etc., with energy being transferred from EV 110 to the other vehicle, device, etc., as represented by direction B in FIG. 1A. In an embodiment, a charge control component (CCC) 119 (as further described) can be configured to monitor respective conditions at plugs 117 and 147 and onboard socket 118, in conjunction with any communications (e.g., between EV 110, EVSE 120, another vehicle (not shown), a laptop (not shown), and suchlike), to determine/control what operation is to be performed at the EV 110, e.g., V2G, V2V, V2Local, V2L, etc.

Grid 130 can be operated locally by a DSO 138, whereby for an EV 110 to engage in V2G operation with grid 130, EV 110 is to be in compliance with various specifications 135A-n, grid codes 137A-n, and suchlike (and associated/respective configurations, parameters, data, etc. (e.g., data/parameters 150A-n)), implemented at grid 130, and communicated between any of EV 110, EVSE 120, grid 130, and/or DSO 138.

As further shown, EV 110 can include a charge control system 111, configured to control charging and discharging operations of batteries 112A-n. Charge control system 111, located onboard EV111, can further include the CCC 119, wherein one or more operations at EV 110 can controlled/performed by CCC 119. CCC 119 can be configured to communicate with an on-board battery charger (OBC) 114 (e.g., an inverter), etc., to control operation (e.g., charging/discharging of batteries 112A-n) in accordance with various operating conditions, e.g., frequency, impedance, voltage, battery temperature, and suchlike. Operation of CCC 119 and OBC 114 can combine to manage functionality of the batteries 112A-n. Numerous computer systems, electronic control units (ECUs) can be located on board EV 110, OBC 114, CCC 119, etc., wherein the respective computers can comprise one or more components present in computer system 180A, as further described. Further, EVSE 120 can also comprise a controller computing system, EVSE controller 122, and also grid 130 can also comprise a controller computing system, grid controller 132, as further described.

In an embodiment, CCC 119 can be configured to implement a local V2G setting 104A-n, wherein the local V2G setting 104A-n can be toggled between an operating condition of “V2G enabled” and “V2G disabled”. Toggling of the operating condition of the local V2G setting 104A-n can be a function of, in a non-limiting list: V2G operation being enabled/disabled at a particular location, grid codes 137A-n being/not being available for a particular location, backend system 126A-n enabling/preventing V2G operation, grid 130 is in an emergency condition, LSFM is implemented/cancelled (as further described), and suchlike, as further described herein. In an embodiment, a local V2G setting 104A can initially be in a “V2G disabled” condition, and it is only with requisite conditions being met (e.g., grid codes 137X is available and V2G operation can be performed) that the local V2G setting 104A is switched to a subsequent condition of local V2G setting 104B is enabled.

Hence, as shown in FIG. 1A, the respective components, devices, etc., enable operation of an EV 110 in any of V2G, V2L, V2V, etc., operation, in accordance with various specifications 135A-n, grid codes 137A-n, and suchlike.

FIG. 1B, system 100B presents a further detailed system configured for operation of a vehicle functioning as an energy source for an electric energy grid, devices, etc., in accordance with one or more embodiments. As shown, EV 110 is connected to EVSE 120, with transmission of electrical energy between the EV 110 and the EVSE 120 conducted via charging cable 116. EVSE 120 is further connected to electrical energy grid 130, e.g., via power line(s) 102.

Batteries 112A-n are located at/onboard EV 110. Charging of the batteries 112A-n can be controlled by the OBC 114 in conjunction with CCC 119, with various data 150A-n (e.g., commands, instructions, etc.) being communicated between OBC 114, CCC 119, and the EVSE 120. Communications between EV 110 and EVSE 120 can be conducted between electric vehicle communication controller (EVCC 115) and supply equipment communication controller (SECC) 125.

EVSE controller system 122 can be configured to control operation of the EVSE 120. SECC 125 can be communicatively coupled to EVCC 115 and a grid communication controller (GCC) 133 at grid 130. GCC 133 can be communicatively coupled to a grid controller component 132 configured to control operation of grid 130 (e.g., in operational compliance with specifications 135A-n and grid codes 137A-n). Data 150A-n can be generated, transmitted, received, and/or processed by any of EVCC 115, SECC 125, GCC 133, and/or I/O 188A-n, as required for operation of EV110 as a generator in compliance with the respective various specifications 135A-n, grid codes 137A-n, and suchlike.

At the initiation of/during charging, various operating checks and handshakes (e.g., regarding charging protocols and conditions) between EVSE 120 and CCC 119 can be initiated/completed (e.g., based upon any of level 1 charging (110-120V), level 2 charging (220-240V), level 3 (400V+) DC fast charging, AC charging, DC charging, battery voltage limit, battery current limit, battery capacity, battery condition, battery deterioration, battery temperature, charge slow down rate, charger capacity, ramping up charging, ramping down charging, charging decay, and the like) and charging has commenced.

EVSE 120 can be a home charging system (e.g., EVSE 120 is located at a home garage), a public charging station comprising one or more charging stations (e.g., EVSE 120 is one of many charging stations located in the public charging station), etc.

Over the years, in lockstep with the development of charging EVs 110, from grid 130, via EVSE 120, various specifications 135A-n (aka regulations) have been developed to ensure a safe charging operation between EV 110 and EVSE 120 in direction A, and furthermore, safe operation of grid 130 with EV 110 connected to EVSE 120. However, with the implementation of BPT, with EV 110/batteries 112A-n operating as an energy source/generator, connection and electrical charging from EV 110 to EVSE 120, in direction B, has to also be in compliance with the respective specifications 135A-n. Also, grid codes 137A-n may also be in place at the grid 130, with which energy generation from EV 110 has to comply. To facilitate compliance with respective specifications 135A-n/grid codes 137A-n, data 150A-n can be transmitted respectively between EV 110 and EVSE 120, wherein data 150A-n can comprise respective instructions, messages, parameters, values, etc., as required. Data 150A-n can be transmitted by any suitable means, e.g., wi-fi, short wave, internet, etc.

During charging of EV 110 at EVSE 120, the charging operation can be monitored, e.g., in accordance with a specification 135A-n/grid codes 137A-n, to detect, for example, overvoltage, undervoltage, grid 130 is in an emergency condition (as further described). In an embodiment, specification 135A-n can be VDE-AR-n 4105. In accordance with the embodiment, by adding VDE-AR-n 4105-related signals into ISO 15118 communications between the EV 110 and the EVSE 120, it is possible to classify the EV 110 as a generator under VDE-AR-n 4105, wherein operation of the EV 110 can be classified independent of the EVSE 120. Accordingly, in the event of an issue arises regarding the power generated by the EV 110, per VDE-AR-n 4105, the EV 110 can be disconnected (e.g., by CCC 119) from the EVSE 120 to prevent damage to grid 130, batteries 112A-n, and suchlike.

Charge control system 111 can further utilize a GPS 105 located onboard EV 110, wherein, GPS signals and data 106A-n generated by the GPS 105 can be stored locally on EV 110 (e.g., in memory 184A). Charge control system 111 can further include a location component 113, wherein location component 113 can be configured to analyze the GPS signals and data 106A-n to determine any of a location of EV 110 (location L), location of EVSE 120, and suchlike. In an embodiment, a location L of EV 110, as determined by location component 113, can be utilized by CCC 119 to identify/request grid codes 137A-n, specifications 135A-n, pertaining to location L, and further determine whether V2G operation(s) can be conducted at the location L.

As previously mentioned, operation of EV 110 (e.g., local V2G setting 104A-n) can be performed/controlled by a user 126A, and can also be performed by other external, backend entities such as an entity at a cloud-based system (CBS) 126C, an OEM system 1260, and suchlike. In an embodiment, while gridcodes 137A-n, specifications 135A-n, and/or data 150A-n can be shared between EVSE 120 and EV 110, gridcodes 137A-n, specifications 135A-n, and/or data 150A-n can be directly installed on the EV 110. For example, the gridcodes 137A-n, etc., can be downloaded to the grid code database 197 via any of, for example, downloading from a memory device (e.g., a flash drive, a thumb drive, memory stick, and suchlike) coupled to the HMI 186A (as further described below). In another embodiment, OEM 1260 can store/flash the grid codes 137A-n, etc., in the grid code database 197 prior to delivery of the EV 110 to entity 126A. During subsequent operation, grid codes 137A-n in grid code database 197 can be updated by OEM 1260 via the EV 110 being taken to a service station/dealer authorized by OEM 1260 (e.g., OEM 1260 uploads grid codes 137A-n to grid code database 197 via HMI 186A). In a further embodiment, the grid codes 137A-n, etc., can be directly transmitted to EV 110 from CBS 126C, e.g., via communication signals 198A-n between CBS 126C and the EV 110 (as further described below). Any suitable technique/technology can be utilized to store and update grid codes 137A-n on the grid code database 197.

As further shown in FIG. 1B, CCC 119, EVSE controller 122, and grid controller 132 can be respectively communicatively coupled to/comprise a computer system(s) 180A-n. For example, a computer system 180A is present/functions onboard EV 110, computer system 180B is present/functions at EVSE 120, computer system 180C is present/functions at grid 130, computer system 180D is present/functions at DSO 138, computer system 180E is available to entity 125A (e.g., owner/operator of EV 110, where computer system 180E is a mobile phone, portable computer, and suchlike), computer system 180F is present/functions at CBS 126C, computer system 180G is present/functions at OEM 1260, and suchlike. In an embodiment, computer system 180A can form/represent functionality of/components located in the CCC 119 in the EV. Respective computer system 180A-n can include a respective memory 184A-n configured to store the respective computer executable components (e.g., CCC 119, location component 113, OBC 114, GPS 105, EVCC 115 at EV 110; EVSE controller 122 and SECC 125 at EVSE 120; grid controller 132 and GCC 133 at grid 130; and suchlike) and further, a respective processor 182A-n configured to execute the computer executable components stored in the memory 184A-n. Memory 184A-n can be further configured to store (e.g., in a grid code database 197) any of local V2G setting 104A-n, data 150A-n, specifications 135A-n, grid codes 137A-n, GPS data 106A-n, instructions 127A-n, grid code map 700A-n, and suchlike. The computer systems 180A-n can further respectively include a human machine interface (HMI) 186A-n (e.g., a display, a graphical-user interface (GUI)) which can be configured to present various information including the data 150A-n, specifications 135A-n, grid codes 137A-n, and suchlike, per the various embodiments presented herein. HMIs 186A-n can include an interactive display/screen 187A-n to present the various information.

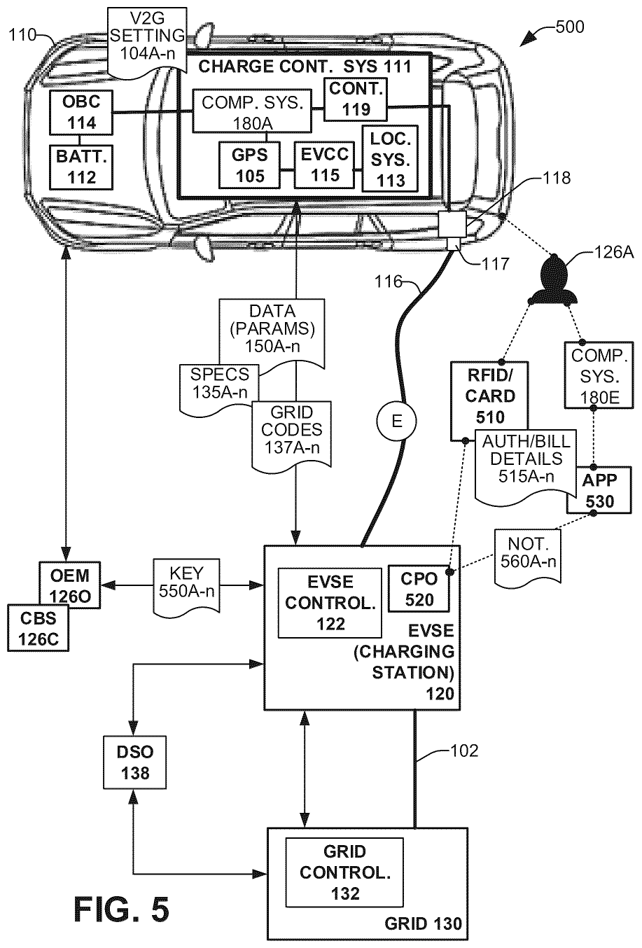

Computer systems 180A-n can further include respective I/O components 188A-n to receive and/or transmit data 150A-n (wherein the data can include the respective messages presented herein). I/O components 188A-n can communicate via signals 191A-n transmitted/received via antenna 189A-n. Signals 191A-n can include instructions, data 150A-n, notifications, grid codes 137A-n, specifications 135A-n, and suchlike, transmitted between respective systems and components presented in FIGS. 1A, 1B, and 5. I/O components 188A-n, EVCC 115, SECC 125, GCC 133, and suchlike, can include respective components to implement the respective telematics and connectivity to enable the respective embodiments presented herein, e.g., to communicate with a comparable I/O system 188A-n respectively operating on any of EVSE 120, grid 130, systems 125A-n, and suchlike, e.g., to facilitate transfer of GPS signals/data 106A-n, grid codes 137A-n, specifications 135A-n (e.g., via any of EVCC 115, SECC 125, GCC 133, and suchlike).

In an embodiment, user 126A can utilize HMI 186A and screens 187A to modify settings, parameters, etc., pertaining to grid codes 137A-n, specifications 135A-n in accordance with user 126A's desired operation of the EV, e.g., during V2G, minimum battery charge, etc. The respective settings applied by user 126A can be compared (e.g., by CCC 119, EVSE 122, backend systems 126B-n, etc.) with the original parameters in the grid codes 137A-n, specifications 135A-n, etc., to ensure that the settings applied by the user 126A do not negatively impact EV 110, the V2G process, and/or the EVSE 120/grid 130.

### 2. High-Level Overview of EV BPT Operation

With a high-level overview, operating EV 110 in a V2G manner can be based on four stages:
Step 1: EV 110 sends a service request message 150A-n to EVSE 120, whereupon the EVSE 120 can identify respective charging features available at EVSE 120, (e.g., alternating current, direct current, etc.).
Step 2: EV 110 and EVSE 120 can exchange respective technical info/limits regarding BPT (charging/discharging) via a charge parameter request and response message pair (e.g., in data 150A-n).
Step 3: based on the respective charging and discharging information, EV 110 can calculate a power profile, wherein a positive power value indicates charging energy and a negative power value indicates a discharging energy. The power profile can be shared by EV 110 with the EVSE 120.
Step 4: during power flow, EV 110 and EVSE 120 can continuously exchange information to enable control of the power flow operation.

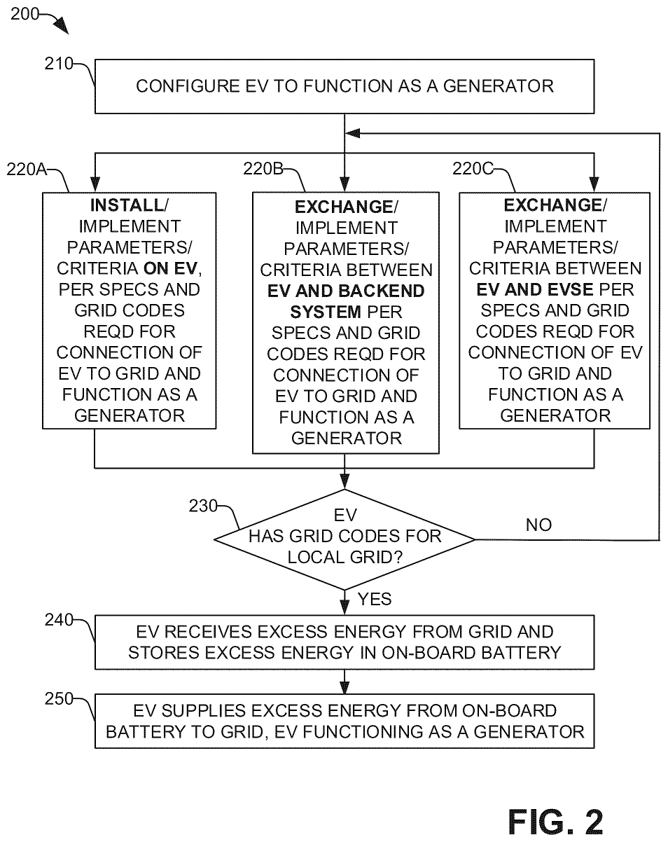

FIG. 2 illustrates a flow diagram 200 for a computer-implemented method to enable an electric vehicle to function as a generator on an electrical energy grid in accordance with respective specifications/regulations/grid codes required for connection/energy provision to a local grid, in accordance with at least one embodiment.

At 210, an EV (e.g., EV 110) can be configured to function as a power source/generator, whereby the EV can be connected to a local grid (e.g., grid 130) via an EVSE (e.g., EVSE 120). In an example scenario of an EV functioning as a power source, during periods of high energy production at the grid, excess energy (e.g., from wind turbines, solar panels, etc.) can be stored in batteries (e.g., batteries 112A-n) on-board the EV. During periods of low energy production at the grid, the excess energy stored in the EV batteries can be supplied/fed-in back to the grid. Further, during normal charging of an EV, the batteries can have energy stored therein, whereby the stored energy can be subsequently utilized to assist in mitigating a grid emergency occurring at the grid, as described further, below.

At 220A-C, as previously mentioned, for an EV to function as a generator, the EV has to operate in compliance with respective specifications/regulations (e.g., specifications 135A-n), grid codes (e.g., grid codes 137A-n), etc., that are implemented at the grid to which the EV is connected/to be connected, e.g., to ensure safe operation of the EV as a generator and prevent damage to/unsafe operation of the grid. As previously mentioned, the grid codes 137A-n can be installed on the EV 110 via downloading/flashing the grid codes 137A-n, etc., from a memory device to the grid code database 197 (step 220A). In another embodiment, grid codes 137A-n, etc., can be downloaded from a backend system 126B-n to the EV 110 and stored in the grid code database 197 (step 220B). In a further embodiment, grid codes 137A-n, etc., can be shared between EV 110 and EVSE 120 (step 220C). During steps 220A-C, respective handshakes and data exchange (e.g., in data 150A-n) can occur between the EV and any of the EVSE 120, the backend system 126B-n, etc., to facilitate respective parameters, variables, settings, instructions, etc., to be exchanged between (e.g., between EVCC 115, SECC 125, GCC 133, backend systems 126B-n, grid code database 197, OBC 114, CCC 119) the EV, the EVSE, backend systems, and the grid, to enable the respective controllers (e.g., CCC 119, EVSE controller 122, grid controller 132) to control and monitor operation of the EV during storage of energy from the grid to the EV, and further, transfer of the stored energy from the EV back to the grid. In an embodiment, a current specification implemented on the EV can be updated/modified to incorporate other elements included in one or more other specifications/grid codes (e.g., VDE-AR-n 4105, EN50549-1, and suchlike) to enable the EV to function in accordance with the other specifications/grid codes. A communication specification (e.g., ISO 15118) can be configured to transmit/receive information as required by the other specifications/grid codes.

At 230, with the EV connected to the EVSE/grid, respective information (e.g., specifications, grid codes) can be shared and a confirmation (e.g., by any of CCC 119, EVSE controller 122, grid controller 132) performed to ensure that the EV is operating in accordance with the respective specifications, regulations, grid codes, etc. In response to a determination of NO, the respective grid codes/parameters are not implemented/being shared with EV 110, method 200 can return to step 220 for the required settings/information to be obtained (e.g., from EVSE, grid). Method 200 can return to step 230 for the confirmation to be performed once more.

At 230, in response to a determination of YES, the respective parameters are being implemented/shared, e.g., at EV 110, method 200 can advance to step 240.

At 240, as previously mentioned, with the EV connected to the grid via the EVSE, excess energy generated at the grid (e.g., during high production/low demand by wind turbines, solar panels, etc.) can be stored by the batteries (e.g., batteries 112A-n) onboard the EV.

At 250, as previously mentioned, during periods of low energy production (e.g., zero wind conditions, night time, etc.) but energy demand by customers of the grid, the energy previously stored in the EV batteries can be transferred back to the grid, with the EV operating as a generator in accordance with the respective specifications, regulations, grid codes, etc., that may be implemented/enforced by the grid to which the EV is connected via the EVSE.

### 3. Grid Code Identification and Updating

As previously mentioned, grid codes 137A-n can comprise technical requirements and rules implemented by the power system operator (e.g., by operator of grid 130, by DSO 138, etc.), whereby a grid code 137A-n can be location specific (e.g., based on the physical location of the grid 130, DSO 138, EVSE 120, and suchlike). Since EV 110 is designed to be mobile in operation, EV 110 is not a stationary generator (e.g., unlike a wind turbine, solar array, and suchlike), the grid codes 137A-n present/available in the EV 110 should be installed/updated in accordance with the current/changing location of the EV 110 to ensure the correct grid code 137A-n (and associated operational parameters) are available at EV 110 prior to enabling V2G functionality. Grid codes 137A-n (and similarly specifications 135A-n) implemented on a grid 130 may be updated at any time, e.g., as a function of operational strain on the grid 130. Further, as power source/generators such as EV batteries 112A-n can function as power sources, current grid codes 137A-n may be amended to enable seamless integration of EV 110 with grid 130. Accordingly, to implement V2G, EV 110 is required to implement the latest/most recent version of an available grid code 137A-n.

In an embodiment, the grid codes 137A-n can be downloaded (e.g., from grid 130/DSO 138) and stored by the CCC 119 (e.g., in memory 184A) at the EV 110.

In an embodiment, respective grid codes 137A-n can be received from a grid 130 which has been pre-approved by the manufacturer/operator, backend system 126A-n, CBS 126C, OEM 1260, of EV 110 for connection/operation of the EV 110 as a power source for the grid 130.

In a further embodiment, implementation of V2G operation by EV 110 at a location L can be controlled by any of the owner 126A and/or backend systems 126B-n. For example, OEM 1260 can deem operation of any of a particular EVSE system 120/grid 130/grid codes 137A-n/specification 135A-n causes damage to batteries 112A-n and accordingly, OEM 1260 prevents implementation of V2G by EV 110 with any of the foregoing, e.g., via a 3^{rd} party instruction 127A-n.

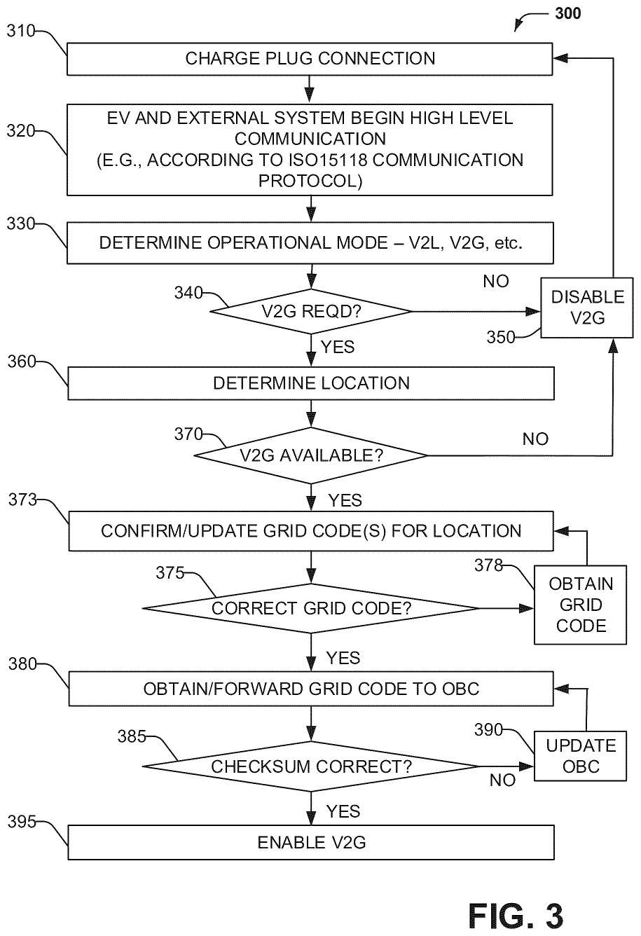

Turning to FIG. 3, flowchart 300 illustrates a computer-implemented process enabling identification and updating of grid codes based on location of an EV in a V2G operation, in accordance with one or more embodiments.

At 310, an EV (e.g., EV 110) is electrically coupled to an external system, wherein the external system can be any of an EVSE (e.g., EVSE 120), another vehicle, a laptop computer, and suchlike. As previously mentioned, the EV can be configured to perform a BPT operation involving any of V2G, V2L, V2V, V2L and, and suchlike. Electrical coupling of the EV to a first external system can be via a first cable (e.g., charging cable 116), wherein the first external system can be an EVSE, wherein the EVSE is further electrically coupled to an energy grid (e.g., grid 130). The grid can be operated by a DSO (e.g., DSO 138). Electrical coupling of the EV to a second external system can be via a second cable (e.g., charging cable 146), wherein the second external system can be another vehicle (e.g., for V2V charging), an electronic device such as a laptop computer (e.g., for V2L and charging), etc. In an embodiment, connection of the first cable or the second to the EV is by a plug (e.g., plug 117 or plug 147) and socket (e.g., socket 118) located onboard the EV.

At 320, the EV and the external system (e.g., computer 180A-n at respective device/EVSE) can conduct high level communication (e.g., to transfer data 150A-n). The communications can be conducted in accordance with any applicable specification, e.g., ISO 15118 communication protocols.

At 330, a control component (e.g., CCC 119) onboard the EV can be configured to determine an operational mode for the EV. Based on any of communication(s) between the EV and the external system, and/or electrical parameter(s) (e.g., frequency, impedance, voltage, etc.), the control component can determine whether a BPT operation is to occur (e.g., with the EV functioning as a power source), and further, the type of BPT operation to be performed, e.g., V2G, V2L, V2V, V2L and, and suchlike.

At 340, in response to a determination (e.g., by CCC 119) that NO, a V2G operation is not to be performed, method 300 can advance to step 350, whereupon V2G operation(s) at the EV be disabled (e.g., by CCC 119), and any of V2L, V2V, V2L and, and suchlike, can be initiated. In an embodiment, local V2G setting (e.g., local V2G setting 104A) is set (e.g., by CCC 119) to V2G operation is disabled.

At 340, in response to a determination (e.g., by CCC 119) that YES, a V2G is intended to be performed, method 300 can advance to step 360, whereupon the location (e.g., location L) of the EV can be determined by an onboard GPS (e.g., GPS 105, location component 113).

At 370, the control component can review the GPS data (e.g., GPS data 106A-n) and available grid codes/V2G parameters (e.g., in grid code database 197) to determine whether (a) V2G can be performed at the current location and/or (b) whether a grid code (and associated operational parameters) are available at the EV for the location. In response to a determination by the control component that NO, V2G is not available for that location, method 300 can return to step 350 whereupon V2G operation(s) at the EV are disabled. In an embodiment, the OEM (e.g., OEM 1260) may not have approved the EVSE at the current location for V2G operation with the EV.

At 370, in response to a determination by the control component that YES, V2G is available/enabled for that location, method 300 can advance to step 373 whereupon the control component can further confirm that a grid code(s) for the location is available at the EV. In an embodiment, the control component can initiate communication with an operator of the grid (e.g., DSO 138) to request/confirm that the grid code(s) at the EV for the location is correct/most recent.

At 375, in response to a determination that NO, the current grid code/parameters at the EV (e.g., in the grid code database 197) are not correct/current, method 300 can advance to step 378, whereupon the operator of the grid can forward the correct/current grid code/parameters to the EV. Upon receipt of the correct/current grid code/parameters, the control component can update the grid code database with the newly received grid code/parameters. Method 300 can return to step 373 to further confirm the newly received grid code/parameters are correct.

At 375, in response to a determination that YES, the current grid code/parameters at the EV (e.g., in the grid code database 197) are correct/current, method 300 can advance to step 380, whereupon the control component can implement the grid code/parameters on the onboard charger (e.g., OBC 114).

At 385, the control component and OBC can perform a checksum operation to confirm that the grid code/parameters provided to the OBC by the control component were correctly received by the OBC. The checksum operation can be conducted to ensure that erroneous settings/parameters are not applied at the OBC which could lead to damage of the battery (e.g., batteries 112A-n), onboard systems, or external systems (e.g., EVSE 120, components of grid 130, and suchlike). In response to a determination by either of the control component, or the OBC, that NO the checksum is not correct, method 300 can advance to step 390, whereupon the grid code/parameters can be resent from the control component to the OBC. Method 300 can subsequently return to step 380/385 to repeat the checksum operation.

At 385, in response to a determination by the control component, or the OBC, that YES, the checksum was successful and the correct grid code/parameters are implemented at the OBC, method 300 can advance to step 395, whereupon the control component can enable/implement V2G operation at the EV. In an embodiment, local V2G setting (e.g., local V2G setting 104A) is set (e.g., by CCC 119) to V2G operation is enabled. It is to be appreciated that while method 300 indicates V2G can be implemented, other checks can be performed, e.g., to ensure the grid is not experiencing a grid emergency condition, and suchlike.

### 4. LFSM Operation

Control of charging/discharging of battery 112A-n can be controlled by a third party. In an example scenario, the third party can be the owner 126A of EV 110, wherein the vehicle owner has configured the discharge/charging operation(s) with a particular schema, aka third party instruction 127A-n. In another example scenario, the third party can also be a remote third party, e.g., where the third party is located in the cloud, a remote centralized control location, and suchlike, e.g., CBS 126C, OEM 1260. OBC 114 can be configured to implement the 3^{rd} party instruction 127A-n to control the discharge/charge operation(s) at the battery 112A-n, e.g., CCC 119 receives the 3^{rd} party instruction 127A-n and operates in conjunction with OBC 114 to implement the 3^{rd} party instruction 127A-n.

Further, a respective grid 130 can operate in accordance with one or more nominal conditions. For example, typically for grids operating/located in Europe, grid 130 can function with a nominal grid frequency of 50 Hz. However, if an operating condition arises where too much power generation occurs at a given load, the grid operating frequency can increase, e.g., can advance to ˜51 Hz. Alternatively, if there is too much load combined with less power generation, the grid operating frequency can decrease, e.g., to ˜48 Hz. When the operational frequency of the grid 130 drifts such that the grid operating frequency has a value beyond a particular threshold value (e.g., either side of the nominal value), grid 130 can be considered to be in an emergency state (aka grid emergency) of operation.

When a grid emergency state arises, according to EN50549-1, and potentially any other applicable country/region specific grid code requirements, a limited frequency sensitive mode (LFSM) operation (e.g., as configured in grid code 137A, conveyed in parameters 150A-n) is to be implemented by a power generator (e.g., at EV 110) to assist grid 130 in returning to a nominal operating condition for the grid 130. In the event of the grid 130 is performing correctly and LFSM operation is not active, operational priority can be given to the 3^{rd} party instruction 127A-n. In an example scenario, the 3^{rd} party instruction 127A-n can require battery 112A-n to be undergoing a charging operation, however, a LFSM operation requires battery 112A-n to undergo a discharging operation to assist the grid 130 in recovering from the grid emergency. Hence, a conflict can arise regarding whether to prioritize implementation of the LFSM mode or the 3^{rd} party instruction 127A-n.

During implementation of LFSM, the CCC 119 and OBC 114 can be configured to adjust active power output at the EV battery 112A-n according to the target grid frequency (e.g., nominal frequency) of grid 130. For example, in the event of an over-frequency situation is occurring at grid 130, then the OBC 114/CCC 119 can be configured to reduce the active power injection to grid 130 by batteries 112A-n, and in the event of an under-frequency situation is occurring at the grid 130, then the OBC 114/CCC 119 can be configured to decrease the power consumption in the event of the EV battery 112A-n was charging and/or EV battery 112A-n increases active power injection to grid in the event of the EV battery 112A-n is discharging. Accordingly, the OBC 114 needs to be informed regarding how to operate charging/discharging of batteries 112A-n.

However, an instruction generated from grid code 137A-n is not to violate a physical safety/operation of the battery 112A-n/EV 110. For example, where the fuse limit of the EV battery 112A-n is set at 20% minimum state of charge (SoC) level, at which the battery 112A-n should be maintained. In the event of the grid instruction violates the 20% SoC, the CCC 119 can be configured to take battery 112A-n offline, e.g., disconnect from the grid 130 at EVSE 120.

In an example sequence of operation:
a) battery 112A-n is currently configured by the third party 126B/C to maintain minimum SoC of 20%;
b) battery 112A-n is currently undergoing charging with power from grid 130, with a current state of 80% SoC at the battery 112A-n;
c) an operating condition(s) of grid 130 causes grid 130 to go into an emergency state, with the charging operation of battery 112A-n being disrupted, and, in response to/compliance with a local grid code 137A, operation of battery 112A-n switches from charging mode to a discharging mode (e.g., per control by CCC 119/OBC 114) supplying energy to grid 130 to assist grid 130 returning to a nominal operating condition;
d) discharging of the battery 112A-n proceeds until the 20% SoC of battery 112A-n is reached, whereby the CCC 119 takes battery 112A-n offline (e.g., until the battery can be recharged once more). Effectively, grid 130 functions as a passive component and does not enforce a specific amount of energy from the EV battery 112A-n, particularly in the event of implementing a LSFM condition at the EV 110 that could damage battery 112A-n, the EV 110, etc.

In another embodiment, EV 110 may be at a location L experiencing cold weather. To prevent damage/operation of the battery 112A-n, performing a discharge operation of battery 112A-n is not recommended, as battery 112A-n can be damaged during cold temperature discharge. Accordingly, CCC 119 can take battery 112A-n offline to prevent discharge during the cold temperature.

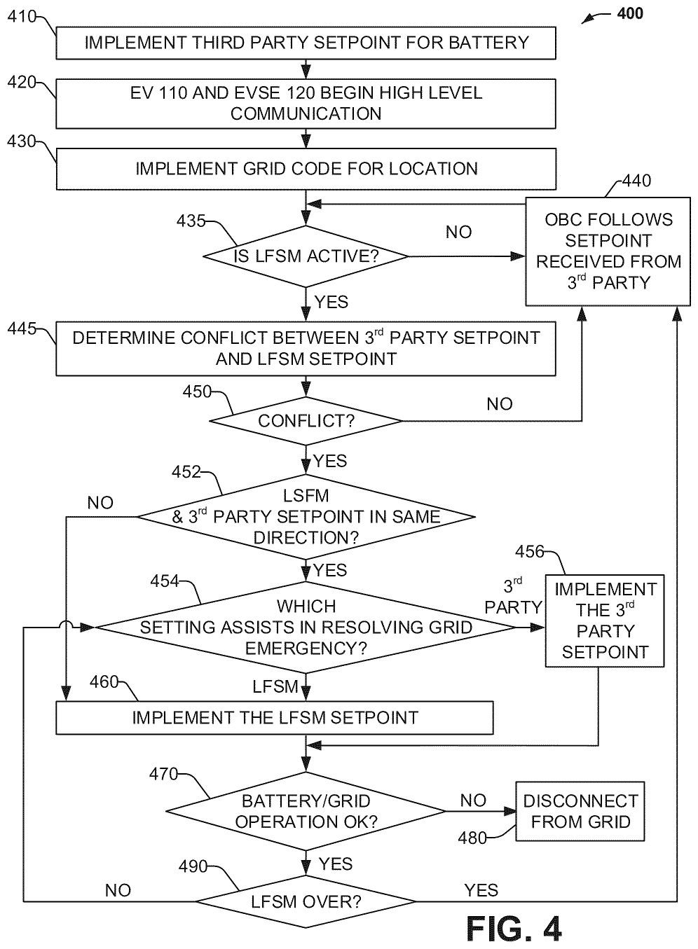

Turning to FIG. 4, flowchart 400 represents a computer-implemented method for resolving conflict of operation between a 3^{rd} party setpoint and a LFSM requirement, in accordance with an embodiment.

At 410, a 3^{rd} party setpoint (e.g., in 3^{rd} party instruction 127A-n) can be configured for implementation on an EV (e.g., EV 110) regarding a charging/discharging operation to be performed at the EV regarding the onboard battery (e.g., battery 112A-n). As mentioned, the 3^{rd} party can be an owner of the vehicle, a centralized system, a cloud system, and suchlike (e.g., any of entities 126A-n).

At 420, the EV can be connected to an EVSE (e.g., EVSE 120) via a charging cable (e.g., charging cable 116), whereupon various communications can be performed, e.g., in accordance with any applicable specification, e.g., ISO 15118 communication protocol.

At 430, as part of the initial communications, a grid code (e.g., grid code 137A) configured for the location (e.g., location L) of the EVSE/EV and associated grid/DSO (e.g., grid 130/DSO 138) can be implemented on the EV.

At 435, current operation of the grid can be monitored/determined (e.g., impedance, frequency, voltage, and suchlike) to determine whether the grid is operating with an expected, normal operation, or a grid emergency is occurring/has occurred. In an embodiment, operation of the grid can be monitored/determined by one or more components onboard the EV, such as an OBC, a control component, and suchlike (e.g., OBC 114, CCC 119, and suchlike). In response to a determination (e.g., by OBC 114) that NO, LFSM is not active and the grid is performing with expected operation, process 400 can advance to 440, where the OBC can continue to function with the 3^{rd} party setpoint. Process 400 can return to 435 for further monitoring of the operating condition of the grid.

At 435, in response to a determination (e.g., by OBC 114, CCC 119 from LFSM data in parameters 150A-n) that YES, a grid emergency is occurring and LFSM is active, process 400 can advance to 445 for a determination to be performed (e.g., by any of OBC 114, CCC 119, and suchlike) regarding whether there is a conflict between the 3^{rd} party setpoint and the LFSM setpoint (e.g., LFSM=charging operation vs 3^{rd} party setpoint=discharging operation).

At 450, in response to a determination (e.g., by any of OBC 114, CCC 119, and suchlike) that NO conflict exists, method 400 can return to step 440 with the 3^{rd} party setpoint remains implemented. Method 400 can subsequently return to step 435 for further monitoring of the grid.

At 450, in response to a determination (e.g., by any of OBC 114, CCC 119, and suchlike) that YES, a conflict may exist between the 3^{rd} party setpoint and the LFSM setpoint, method 400 can advance to step 452 where further logic can be applied regarding a determination (e.g., by OBC 114, CCC 119, and suchlike) regarding whether the LFSM and 3^{rd} party setpoint are in the same direction? Here the term “direction” is used regarding whether the LFSM and the 3^{rd} party setpoint are both directed towards charging (same direction), both discharging (same direction), LFSM is for charging while 3^{rd} party setpoint is for discharging (not in same direction), LFSM is for discharging while 3^{rd} party setpoint is for charging (not in same direction).

At 452, in response to a determination that NO, LFSM and the 3^{rd} party setpoint are NOT in same direction, method 400 can advance to step 460, whereupon, in accordance with implementing/being in compliance with the grid code (and accordingly enabling EV 110 to connect to the grid 130) the LFSM setpoint can be implemented at the EV, e.g., at the OBC.

At 452, in response to a determination that YES, LFSM and the 3^{rd} party setpoint are in the same direction, method 400 can advance to step 454, whereupon, a further determination (e.g., by any of OBC 114, CCC 119, and suchlike) can be made regarding which of the LFSM setpoint or the 3^{rd} party setpoint best assist grid 130 in resolving the grid emergency at grid 130. For example, the LFSM setpoint might be set to transfer at 5 kWh (kilowatts/hour) while the 3^{rd} party setpoint is set to transfer at 10 kWh. Hence, the 3^{rd} party setpoint might assist in resolving the grid emergency faster than the LFSM setpoint.

At 454, in response to a determination that the 3^{rd} party setpoint best assists recovery of grid 130, method 400 can advance to step 456, whereupon the 3^{rd} party setpoint can be implemented. Method 400 can further advance to step 470, for subsequent determination of whether the battery and/or the grid are in condition for the charging/discharging operation to be resumed.

At 454, in response to a determination that the LFSM setpoint best assists recovery of grid 130, method 400 can advance to step 460, whereupon the LFSM setpoint can be implemented. Method 400 can further advance to step 470, for subsequent determination of whether the battery and/or the grid are in condition for the charging/discharging operation to be resumed.

At 470, as part of implementing the LFSM setpoint or the 3^{rd} party setpoint, a determination can be made (e.g., by the OBC 114, CCC 119) regarding whether implementing the LSFM setpoint or the 3^{rd} party setpoint may damage any of the EV batteries (e.g., batteries 112A-n), one or more systems onboard the EV, the EVSE, the grid, and suchlike. In response to a determination that NO, the LSFM setpoint or the 3^{rd} party setpoint should not be implemented on the battery, method 400 can advance to step 480, whereupon the EV/battery can be disconnected from the grid (e.g., by CCC 119). Charging/discharging concerns can include, in a non-limiting list: charge at the battery may be at a minimum charge setpoint, battery temperature is too low, etc.

At 470, in response to a determination that YES, the LSFM setpoint or the 3^{rd} party setpoint can be implemented on the battery, method 400 can advance to step 490, whereupon continued monitoring of the grid can be conducted (e.g., by any of OBC 114, CCC 119, and suchlike). In response to a determination of YES, the LFSM/grid emergency is over, method 400 can return to step 440 with the 3^{rd} party setpoint being applied to the OBC.

At 490, in response to a determination that NO, the LFSM/grid emergency is still in effect, method 400 can return to step 460 for continued implementation of the LSFM setpoint and further monitoring of operation of the grid/EV batteries.

### 5. Temporary Disconnection/Automatic Reconnection

FIG. 5, system 500, presents a system diagram representing maintaining charging of an EV in the event of temporary disconnection, in accordance with an embodiment. In an example scenario of operation, EV 110 can be connected to EVSE 120 (e.g., a wallbox), wherein EVSE 120 may be a charging system at a public charging facility. As part of the charging/discharging operation, operator 126A of EV 110 submits authentication information and/or billing account information 515A-n, e.g., via a swipeable card, RFID card 510 for a chargepoint operator (CPO) system 520 associated with the EVSE 120. EVSE 120 can be configured to authenticate operator 126A, access the billing account associated with card 510, initiate charging of EV 110 at EVSE 120, and transfer funds from operator 126A's account to the CPO 520 account regarding amount of energy transferred.

However, in the event of an electrical/system disturbance occurring at grid 130 (e.g., an emergency condition at grid 130, a temporary power blackout at grid 130, and suchlike), EV 110 can be configured to temporarily cease a charging/discharging operation at the EVSE 120, but the EV 110 remains connected to EVSE 120 via charging cable 116. Such a scenario can occur, for example, at a public charging facility where operator 126A has stepped away from EV 110 (e.g., operator 126A is dining at a restaurant at the charging facility while the charging operation is being performed). Upon the grid 130 returning to an expected operating condition, it is preferred that the charging/discharging operation re-initiates between EVSE 120 and EV 110. However, per the example scenario, operator 126A is not present to re-authenticate/re-initiate billing.

Accordingly, per the various embodiments presented herein, EV110 and EVSE 120 can be configured to automatically resume charging/discharging of EV 110. CPO system/account 520 can be connected/incorporated into the EVSE controller system 122. Further, the EVSE 120 and CPO 520 can be known/pre-registered/authorized/pre-approved by any of the operator 126A, the OEM 1260, third party operator 126C (e.g., cloud operator), and suchlike. In an example embodiment, the CPO system 520 (e.g., via EVSE 120) can be in communication with the backend system 126B-n, whereupon the CPO system 520 (via the EVSE 120) can request the backend system 126B-n to authorize/approve recommencing of the charging operation without operator 126A having to intervene and re-perform the authorization/authentication process. In an embodiment, as part of CPO system 520 pre-registering with the backend system 126B-n, an authentication code/key 550A-n (e.g., a shared key, cryptographic key, and suchlike) can be shared between the CPO system 520 and the backend system 126B-n, whereupon the CPO system 520 can re-present the authentication code 550A-n to the backend system 126B-n for authentication of the CPO system 520 by the backend system 126B-n, whereupon (e.g., after performing any required grid observations, as further described) charging/discharging can be recommenced between the EVSE 120 and EV 110.

In an alternative embodiment, a software application 530 can be installed on operator 126A's cellphone (e.g., computer system 180E), such that in the event of EV 110 temporarily disconnecting from EVSE 120, EVSE 120/CPO 520 can be configured to transmit a notification 560A-n to the application 530 informing the operator 126A of the change in status of the charging/discharging operation. Further, once charging/discharging can be resumed (e.g., grid emergency has been resolved), software application 530 can notify operator 126A of the ability to resume charging, which operator 126A can authorize in a notification 560A-n via the software application 530.

As part of initiating and/or recommencing the charging/discharging operation, in accordance with specifications 135A-n, grid codes 137A-n, etc., EV 110 may have to wait a defined period of time (e.g., 60 seconds) while the quality of operation of grid 130 is monitored/assessed. CCC 119 can be configured to determine the quality of operation of grid 130. In the event of a determination by CCC 119 that the operating conditions (e.g., frequency/voltage) of grid 130 are within acceptable limits, EV 110 can commence/recommence energy discharge to/charging from grid 130. Accordingly, EV 110 has intelligence (e.g., at CCC 119) to monitor operating condition of grid 130 to prevent damage to grid 130 or battery 112A-n in the event of charging/discharging being recommenced.

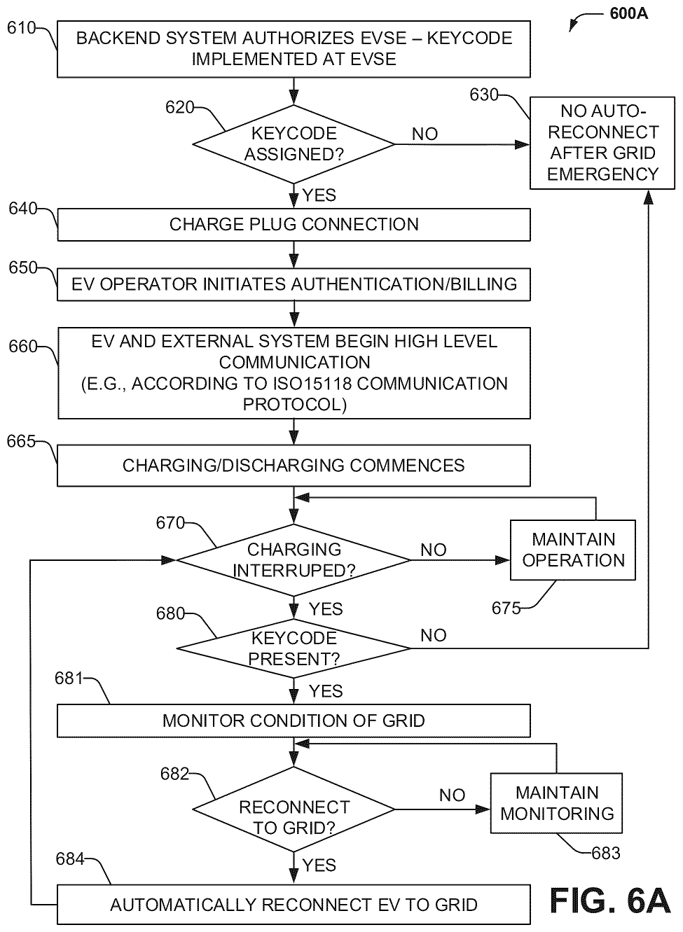

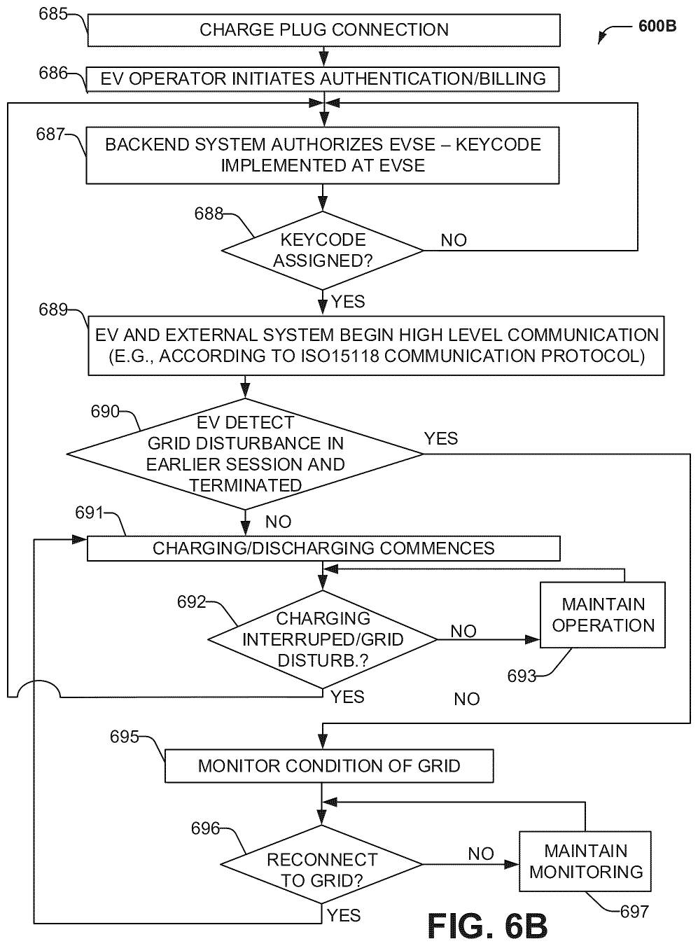

FIG. 6A, flowchart 600A, presents a computer-implemented method to re-commence charging/discharging operations at an EV after a temporary disconnection from a grid, in accordance with an embodiment.

At 610, charging/discharging at a EVSE (e.g., EVSE 120) for an EV (e.g., EV 110) can be authorized by a backend system (e.g., system 126A-n), whereby an authentication key/code (e.g., key 550A-n) can be generated at the backend system to be shared with/implemented at the EVSE.

At 620, with the EV located at the EVSE, a determination can be made (e.g., by CCC 119, EVSE controller 122, etc.) regarding whether the EVSE is pre-authorized by the backend system to conduct charging/discharging of the EV. In response to determining that NO authorization key is present at the EVSE, method 600A can advance to step 630, whereupon, in the event of a disconnection of EV from the grid, no auto-reconnect operation (e.g., by CCC 119, EVSE controller 122) can be performed.

At 620, in response to determining that YES, an authorization key is present at the EVSE, method 600A can advance to step 640, whereupon, connection of the charging cable (e.g., cable 116) to the EVSE can be performed. (Steps 610-640 can be performed in any sequence).

At 650, operator (e.g., operator 126A, backend systems 126B-n) can initiate authentication/billing, for example, the operator authenticates with a card (e.g., card 510) at a chargepoint system (e.g., CPO system 520).

At 660, as previously described, during initiation of charging/discharging, communications/handshakes can occur between the EV and EVSE, e.g., to ensure conditions at the EV/grid are correct for safe charging/discharging.

At 665, the required charging/discharging operation is performed between the EV, EVSE, and the grid (e.g., grid 130). In an embodiment, local V2G setting (e.g., local V2G setting 104A) is set (e.g., by CCC 119) to V2G operation is enabled.

At 670, the charging/discharging operation can be continuously monitored (e.g., by CCC 119, OBC 114, EVSE controller 122, grid controller 132, and suchlike) to ensure that the operating conditions at the EV (e.g., batteries 112A-n) and the EVSE/grid are as required for safe charging/discharging. At 670, in response to a determination (e.g., by any of CCC 119, OBC 114, EVSE controller 122, grid controller 132, and suchlike) that the operating conditions are acceptable (e.g., comport to a grid code 137A implemented at the EV 110/EVSE 120, across grid 130), method 600A can advance to step 675, whereupon the charging/discharging operation can be maintained, with method 600A returning to step 670 for further monitoring of the operating conditions to be performed.

At 670, in response to determining (e.g., by any of CCC 119, OBC 114, EVSE controller 122, grid controller 132, and suchlike) the charging/discharging operation being interrupted (e.g., a grid emergency is occurring, local V2G setting is set by CCC 119 to disabled), method 600A can advance to step 680, whereupon a determination (e.g., by any of CCC 119, EVSE controller 122, CPO system 520, and suchlike) can be performed to determine whether the authentication key is present. In response to a determination that NO authentication key is present, method 600A can return to step 630, whereby the EV is prevented from reconnecting to the grid when the operating conditions have returned to an acceptable condition. In an embodiment, local V2G setting (e.g., local V2G setting 104A) is set (e.g., by CCC 119) to V2G operation is maintained at disabled.

At 680, in response to a determination that YES, an authentication key is present, method 600A can advance to step 681, whereupon the condition of the grid can be monitored for a required period of time/observation time (e.g., to ensure grid is in a safe operating condition, ensure batteries are in a safe operating condition).

At 682, in response to a determination that NO, the grid/batteries is not in a safe operating condition, method 600A can advance to step 683, whereupon further monitoring of the operating condition(s) can be performed, with method 600A returning to step 682 for further monitoring to be performed. In an embodiment, local V2G setting (e.g., local V2G setting 104A) is set (e.g., by CCC 119) to V2G operation maintained at disabled.

At 682, in response to a determination that YES, the grid/batteries are in a safe operating condition, method 600A can advance to step 684, whereupon the charging/discharging operation can be recommenced. In an embodiment, local V2G setting (e.g., local V2G setting 104A) is set (e.g., by CCC 119) to V2G operation is enabled.

FIG. 6B, flowchart 600B, presents a computer-implemented method to re-commence charging/discharging operations at an EV after a temporary disconnection from a grid, in accordance with an embodiment.

At 685, an EV (e.g., EV 110) can be coupled to an EVSE (e.g., EVSE 120) by connecting a charging cable (e.g., cable 116) from the EVSE, e.g., charging cable plug (e.g., plug 117) is connected to socket (e.g., socket 118) on the EV.

At 686, operator (e.g., operator 126A, backend systems 126B-n) can initiate authentication/billing, for example, the operator authenticates with a card (e.g., card 510) at a chargepoint system (e.g., CPO system 520).

At 687, charging/discharging at a EVSE (e.g., EVSE 120) for an EV (e.g., EV 110) can be authorized by a backend system (e.g., system 126A-n), whereby an authentication key/code (e.g., key 550A-n) can be generated at the backend system to be shared with/implemented at the EVSE.

At 688, with the EV located at the EVSE, a determination can be made (e.g., by CCC 119, EVSE controller 122, etc.) regarding whether the EVSE is pre-authorized by the backend system to conduct charging/discharging of the EV. In response to determining that NO authorization key is present at the EVSE, method 600B can return to 687 for further authorization.

At 688, in response to determining that YES, an authorization key is present at the EVSE, method 600B can advance to step 689, whereupon, connection of the charging cable (e.g., cable 116) to the EVSE can be performed.

At 689, as previously described, during initiation of charging/discharging, communications/handshakes can occur between the EV and EVSE, e.g., to ensure conditions at the EV/grid are correct for safe charging/discharging.

At 690, a determination can be made regarding whether a grid disturbance (e.g., a grid emergency, blackout) was detected (e.g., by CCC 119 on EV 110) for an earlier charging/discharging session and was terminated. In response to a determination of YES, a disturbance was detected, method 600B can move to step 695 (as further described). At 690, in response to a determination of NO disturbance was detected, method 600B can advance to step 691.

At 691, the required charging/discharging operation is performed between the EV, EVSE, and the grid (e.g., grid 130). In an embodiment, local V2G setting (e.g., local V2G setting 104A) is set (e.g., by CCC 119) to V2G operation is enabled.

At 692, the charging/discharging operation can be continuously monitored (e.g., by CCC 119, OBC 114, EVSE controller 122, grid controller 132, and suchlike) to ensure that the operating conditions at the EV (e.g., batteries 112A-n) and the EVSE/grid are as required for safe charging/discharging. At 692, in response to a determination (e.g., by any of CCC 119, OBC 114, EVSE controller 122, grid controller 132, and suchlike) that the operating conditions are acceptable (e.g., comport to a grid code 137A implemented at the EV 110/EVSE 120, across grid 130), method 600B can advance to step 693, whereupon the charging/discharging operation can be maintained, with method 600B returning to step 692 for further monitoring of the operating conditions to be performed.

At 692, in response to determining (e.g., by any of CCC 119, OBC 114, EVSE controller 122, grid controller 132, and suchlike) the charging/discharging operation has been interrupted (e.g., a grid emergency is occurring, local V2G setting is set by CCC 119 to disabled), method 600B can return to step 687 for further authentication of the authentication code.

As mentioned, step 690 can advance to step 695 (e.g., in response to a determination that a grid disturbance was detected), whereupon, at step 695, the condition of the grid can be monitored for a required period of time/observation time (e.g., to ensure grid is in a safe operating condition, ensure batteries are in a safe operating condition).

At 696, in response to a determination that NO, the grid/batteries is not in a safe operating condition, method 600B can advance to step 697, whereupon further monitoring of the operating condition(s) can be performed, with method 600B returning to step 696 for further monitoring to be performed. In an embodiment, local V2G setting (e.g., local V2G setting 104A) is set (e.g., by CCC 119) to V2G operation maintained at disabled.

At 696, in response to a determination that YES, the grid/batteries are in a safe operating condition, method 600B can return to step 691, whereupon the charging/discharging operation can be recommenced. In an embodiment, local V2G setting (e.g., local V2G setting 104A) is set (e.g., by CCC 119) to V2G operation is enabled.

### 6. Multiple Energy Providers in a Region

Generally, grid codes 137A-n (and associated operational parameters) can be country specific (i.e., same nominal operating frequency across the country), or specific to a DSO 138A-n providing access/billing to the grid 130. Similarly, specifications 135A-n are also generally specific to a geographic region, e.g., those countries implementing respective ISO, IEC, VDE, EN, and suchlike specifications. However, it is possible that different grid codes 137A-n, specifications 135A-n (and associated parameters) are implemented within a country/specific geographic region, e.g., grid code 137X for a first region serviced by a first DSO 138X and grid code 137Y for a second region serviced by a second DSOY.

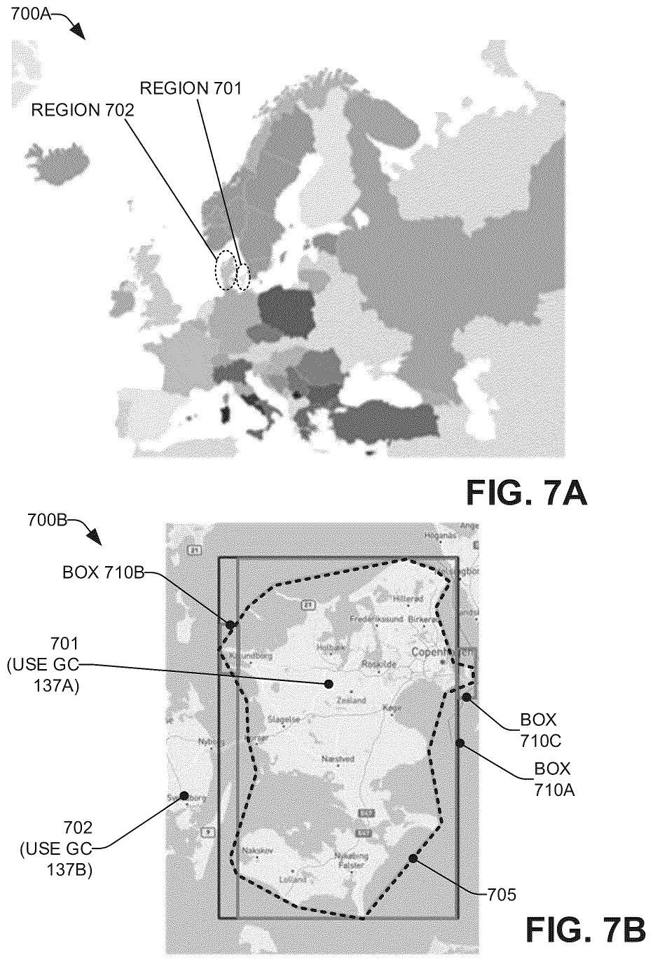

FIG. 7A, schematic 700A, presents a map of Europe providing an example of different regions to implement grid codes 137A-n for Denmark. Denmark utilizes different grid codes 137A-n in two different regions of the country. Hence, as EV 110 navigates across Denmark, compliance with a first grid code 137A is required for BPT operations in a first region, region 1/701, of Denmark, while compliance with a second grid code 137B is required for BPT operations in a second region, region 2/702, of Denmark. Hence, it is required that the respective regions are sufficiently defined to enable a first location L1 (e.g., in region 1) and a second location L2 (e.g., in region 2) to be accurately determined to enable the correct grid code 137A-n to be utilized (and correct billing of EV 110).

FIG. 7B, schematic 700B, presents a boundary box approach to demarcate respective regions of implementation of respective grid codes and specifications, in accordance with one or more embodiments.

As shown, with Denmark functioning as an example of particular geographic region, e.g., a country, a first region 701 can be mapped out with regard to a second region 702. Boundary of region 701 can be marked by boundary line 705. Region 701 inside boundary line 705 can be captured within three boundary boxes 710A-C. When an EV 110 is located within boundary boxes 710A-C, a grid code 137A can be implemented, and when EV 110 is located in Denmark but outside of boundary boxes 710A-C, a grid code 137B for region 702 can be implemented at EV 110. A grid code map 700B can be generated and stored (e.g., at CBS 126C, OEM 1260) with the boundary boxes 710A-C implemented thereon, along with regions 701, 702, other countries, etc., identified. The grid code map 700B can be configured and downloaded to the EV 110 (e.g., in stored in memory 184A/grid code database 197) for implementation by CCC 119. Hence, with the grid code map 700B located on EV 110, in conjunction with GPS data 106A-n, CCC 119 can be configured to identify a current/future location of EV 110 and further configured to select and implement (e.g., from grid code database 197) which grid code 137A-n is to be implemented for BPT operations at the respective location L. It is to be appreciated that Denmark is utilized herein as an example of a geographic region with more than one grid codes 137A-n being implemented, and the boundary box 710A-n approach can be utilized for any geographic region in which disparate grid codes 137A-n are required and the grid codes 137A-n are implemented/updated are required for the respective one or more regions.

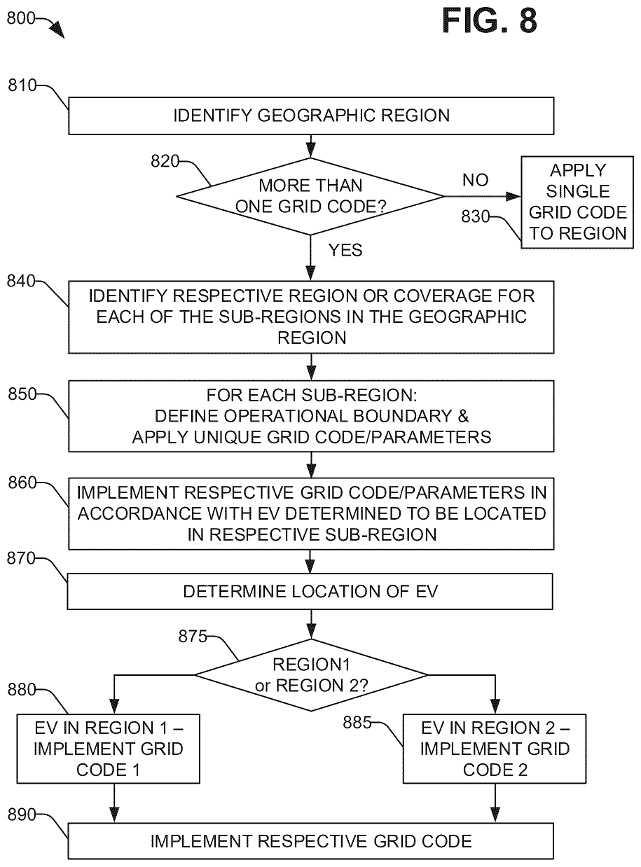

FIG. 8, flowchart 800, illustrates a computer-implemented method to apply/implement more than one grid code/specification in a geographic region, in accordance with an embodiment.

At 810, a geographic region of interest is identified on a grid code map (e.g., grid code map 700B), wherein the region can be a continent, a country, a region within a country, etc. GPS co-ordinates can be utilized to create regions (e.g., regions 701, 702, etc.) and respective boundaries (e.g., boundary 705) on a grid code map (e.g., grid code map 700B). Any suitable approach can be utilized, e.g., drawing respective regions on a digital map with a digital pen while referencing one or more region(s) defined by operator of grid 130, and suchlike. Interaction with/modification of the grid code map can be performed at a backend system (e.g., backend systems 126A-n and associated computer systems 180F-n).

At 820, a determination can be made regarding whether more than one grid code/specification (e.g., grid codes 137A-n, specifications 135A-n) are to be implemented by an EV (e.g., EV 110 when undergoing V2G operation). In response to a determination that NO, only a single grid code/specification is to be implemented, method 800 can advance to step 830, whereupon a single grid code/specification can be added/implemented at the region.

At 820, in response to a determination that YES, more than one grid code/specification is to be implemented in the geographic region, method 800 can advance to step 840, whereupon the respective sub-regions to apply the respective grid code can be identified.

At 850, for each sub-region, an operational boundary for each of the grid codes/specifications can be drawn on the grid code map. In an embodiment, the previously described boundary box (e.g., boxes 710A-n) approach can be utilized to combine respective portions of a sub-region together.

At 860, the grid code map with identified regions and grid code boundaries (e.g., boxes 710A-n) can be stored (e.g., at a backend system 126B-n) and further transmitted to the EV for implementation (e.g., grid code map is saved in grid code database (e.g., grid code database 197)).

At 870, location determination of the EV can be performed, e.g., based on GPS location (e.g., by location component 113, GPS 105).

At 875, based on location of the EV, a determination (e.g., by CCC 119) can be made regarding whether EV is in a first zone (e.g., first region 701) or a second zone (e.g., second region 702). At 875, in response to a determination that the EV is in the first zone, method 800 can advance to step 880, whereupon the first grid code (e.g., grid code 137A) pertaining to first zone can be implemented. As described herein, one or more operations can be performed to ensure the first grid code is the most recent version before the EV conducts V2G operation. Method 800 can advance to step 890, whereupon V2G operation with the first grid code can be implemented.

At 875, based on determining the EV is in the second zone, the second grid code (e.g., grid code 137B) assigned to the second zone can be implemented. As described herein, one or more operations can be performed to ensure the second grid code is the most recent version before the EV conducts V2G operation. Method 800 can advance to step 890, whereupon V2G operation with the second grid code can be implemented.

### 7. V2G Available in Region?

V2G may not be available in all regions across the globe that an EV 110 may be operated. Accordingly, prior to performing a V2G operation, a check can be made to determine whether V2G is available at a current location L, wherein the current location can be determined by GPS 105 and location component 113, and suchlike, as previously mentioned. In the event of V2G operation is not available at a given location L, then CCC 119 can be configured to disable V2G operation at the EV, e.g., to ensure safety of the EV 110 and/or the grid 130. In an embodiment, disabling of V2G operation at EV 110 can be performed automatically by CCC 119, whereby CCC 119 disables V2G for OBC 114. In an embodiment, CCC 119 can be configured to review grid code database 197 to identify whether any grid codes 137A-n have been approved for implementation at the current location L. EV 110 can have an initial setting in parameters 150A-n that V2G is disabled. In response to identifying no grid codes 137A-n have been approved, CCC 119 can:
(a) transmit a confirmation request to the backend system 126B-n as to whether V2G can be performed at the current location L, and in the event of backend system 126B-n indicates YES, backend system 126B-n can transmit the applicable grid code 137N for implementation by CCC 119 at the current location L;
(b) transmit a confirmation request to the backend system 126B-n as to whether V2G can be performed at the current location L, and in the event of backend system 126B-n indicates NO, backend system 126B-n can transmit an instruction that no V2G is to be performed by EV 110 at the current location L; or
(c) in response to identifying that there are no grid codes 137A-n pertaining to the current location, CCC 119 can automatically disable V2G at the current location L (e.g., without performing a confirmation operation per (a) and (b).

In another embodiment, while V2G may be performed at a particular location L, the operator of the charging station (e.g., EVSE 120) and/or the grid 130, DSO 138, etc., may not be approved for V2G operation by the OEM 1260/3^{rd} party operator 126C (e.g., at the backend system), whereby, while a grid code 137P is available (and potentially present) in the grid code database 197, the grid code 137P can be flagged with a “do not use” or similar identifier, informing CCC 119 not to implement grid code 137P.

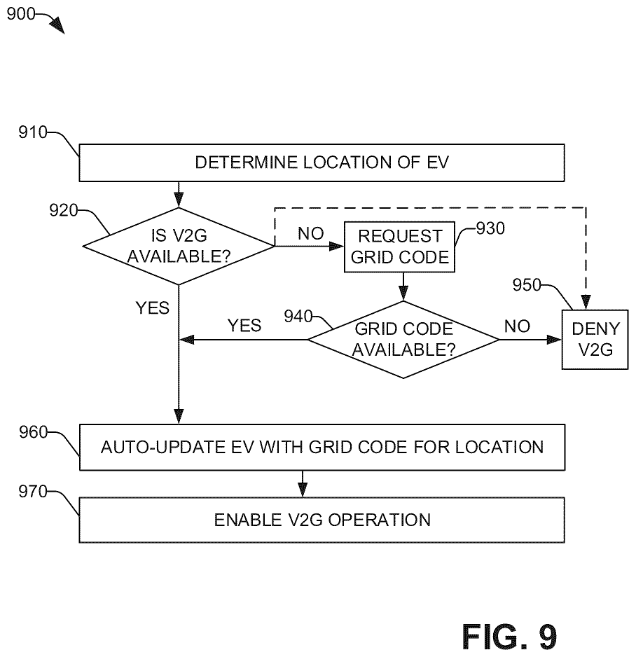

FIG. 9, flowchart 900, present a computer-implemented method to control V2G operation of an EV based upon grid code availability, in accordance with an embodiment.

At 910, a current location of an EV (e.g., EV 110 at location L) is determined, wherein the EV is connected to an EVSE (e.g., EVSE 120) with the intention of a V2G operation is to be performed. Any suitable technique/technology of determining the location of the EV can be used. For example, current location of the EV can be determined based on a GPS location process performed (e.g., by CCC 119 in conjunction with GPS data 106A-n provided by GPS 105) at the EV. In another example, current location of the EV can be obtained from location/GPS information provided by the EVSE.

At 920, a determination can be made by a control component (e.g., CCC 119) onboard the EV regarding whether V2G operation is available? The control component can be configured to determine whether a grid code/parameters (e.g., grid code 137A-n) is present in a grid code database (e.g., grid code database 197) located on the EV for the current location (e.g., location L). In response to a determination that NO, there is no grid code in the grid code database pertaining to the location of the EV, method 900 can proceed to step 930, whereupon, in an embodiment, in the event of the control component does not identify a grid code present in the grid code database for the location, the control component can communicate with an external/backend system (e.g., CBS 126C, OEM 1260) to determine whether the backend system has a grid code that is to be forwarded to the EV for V2G operation at the location. At 940, the backend system can determine whether a grid code/parameters exist in a grid code database (e.g., grid code database 197) at the backend system for the location of the EV? In the event of NO grid code is identified, method 900 can advance to step 950 whereupon the backend system can instruct (e.g., instructions 127A-n) the EV that V2G operation is disabled/denied for the current location. In the event of YES, a grid code is identified, the backend system can forward the grid code to the EV for implementation at the EV. In an embodiment, as shown by the hashed line, at 920, in the event of no grid code is identified at the EV for the current location, method 900 can advance directly to step 950, with V2G operation being denied (e.g., no request is made to the backend system for a grid code).

At 920 (and also with grid code available at 940), in response to a determination (e.g., by CCC 119) that V2G is available for the location, method 900 can advance to step 950, whereupon the grid code/parameters can be forwarded to the onboard charger (e.g., OBC 114) to the EV is denied performing V2G operation. Accordingly the EV can undergo charging of the onboard batteries (e.g., batteries 112A-n) at the EVSE (e.g., by energy provided by grid 13), but the EV cannot function as a power source/generator at the location/EVSE for the grid connected to the EVSE. In an embodiment, local V2G setting (e.g., local V2G setting 104A) is set (e.g., by CCC 119) to V2G operation is disabled.

At 920, in response to a determination that YES, a grid code exists for the location, method 900 can advance to step 960, whereupon the grid code at the OBC can be automatically updated. (As previously described, one or more checksum operations can be performed to ensure the grid code is provided as expected by the control component to the OBC).

At 970, V2G operation can be implemented at the location for the EV. In an embodiment, local V2G setting (e.g., local V2G setting 104A) is set (e.g., by CCC 119) to V2G operation is enabled.

### 8. Controlling V2G by an External Entity

As previously mentioned, grid codes 137A-n can be shared and implemented across the V2G system, e.g., at EV 110, at EVSE 120, at grid 130, by DSO 138, etc. In an embodiment, rather than either of the grid 130 or the DSO 138 generating and/or forwarding grid codes 137A-n directly to EV 110 (e.g., via EVSE 120), DSO 138 can forward grid codes 137A-n to a central system, e.g., CBS 126C, whereby the CBS 126C is configured to share respective grid codes 137A-n with one or more EV 110's which are communicatively coupled to CBS 126C.

In an embodiment, CBS 126C can be configured to function as an intermediary system between EV 110 and grid 130, forwarding grid codes 137A-n to the EV 110 as the grid codes 137A-n are received at the CBS 126C (e.g., from DSO 138, grid 130). Hence, any EV 110 in communication with CBS 126C effectively has access to the same set/common set of grid codes 137A-n (e.g., stored in grid code database 197) as those present/available at CBS 126C.

In another embodiment, EV 110 can be configured to only initiate V2G after approval from CBS 126C. In an embodiment, EV 110 can be configured to transmit location information (e.g., GPS data 106A-n) for a particular location L to CBS 126C, CBS 126C confirms the grid code 137A to be implemented at location L, forwards operational parameters 150A-n/grid code 137A to EV 110 in conjunction with authorization for EV 110 to conduct V2G operations. In an initial condition of operation, V2G operations at EV 110 are initially disabled (e.g., local V2G setting 104A is set by CCC 119 to V2G operation is disabled), with V2G operation(s) only being enabled at EV 110 after authorization from CBS 126C. In a further embodiment, once a V2G operation has been performed by EV 110 connected to grid 130, configuration of V2G operation at EV 110 returns once again to a V2G operation is disabled, until the EV 110 subsequently requests and is authorized by CBS 126C to perform a V2G operation at the current location of EV 110 or a subsequent location of the EV 110.

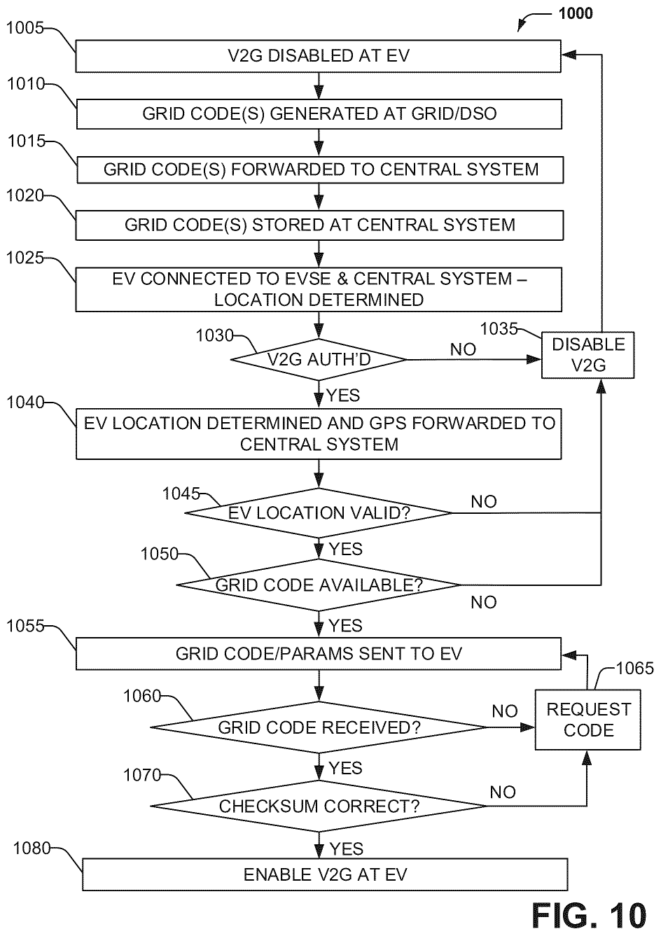

FIG. 10, flowchart 1000 presents a computer-implemented method for controlling, by an external system, V2G operation(s) at an EV, in accordance with at least one embodiment.

At 1005, EV (e.g., EV 110) is configured with an initial condition of V2G functionality is disabled. In an embodiment, local V2G setting (e.g., local V2G setting 104A) is set (e.g., by CCC 119) to V2G operation is disabled.

At 1010, one or more grid codes (e.g., grid codes 137A-n) are generated by one or more entities such as an operator of a grid (e.g., operator of grid 130) or a DSO (e.g., DSO 138).

At 1015, the one or more grid codes are transmitted to the backend system (e.g., CBS 126C, OEM 1260).

At 1020, the one or more grid codes can be stored at the backend system (e.g., in memory 184E-n).

Act 1025, operator (e.g., owner 126A) of EV connects EV to an EVSE (e.g., to EVSE 120) at location L. As previously mentioned, communications can be established between the EV and EVSE in preparation for the V2G operation to be conducted. In an embodiment, at the time of EV being connected to EVSE, location L of the EV/EVSE can be determined, e.g., by a GPS (e.g., GPS 105, location component 113) located on the EV, GPS information (e.g., GPS data 106A-n) provided by EVSE, and suchlike. In an embodiment, local V2G setting (e.g., local V2G setting 104A) can be initially set (e.g., by CCC 119) to V2G operation is disabled.

Act 1030, a determination can be made (e.g., by CCC 119) regarding whether the EV can perform V2G at the current location L. In response to NO, V2G is not available at this location, method 1000 advances to step 1035, whereupon V2G (e.g., local V2G setting 104A) remains disabled at the location. Method 1000 can return to step 1005, per the next time the EV is connected to perform V2G.

At 1040, in response to a determination (e.g., by CCC 119) that EV is located at a location where V2G can be performed, the GPS location (e.g., location L) of EV can be forwarded to a backend system (e.g., CBS 126C, OEM 1260). Method 1000 can advance to step 1045.

At 1045, the backend system can be configured to determine that the EV location L is valid for V2G operation. Backend system can be configured to determine whether any of data (e.g., grid code database 197) indicates that V2G can be performed, V2G cannot be performed, and/or a grid code 137A-n is available for V2G to be performed at the location L. In response to a determination by the backend system that V2G is disabled/unavailable for location L, method 1000 can return to 1035, whereupon V2G for the EV remains disabled at the location (e.g., local V2G setting 104A remains disabled).

At 1045, in response to a determination that YES, V2G is available/enabled at location L, method 1000 can advance to step 1050. At 1050, the backend system can determine whether a grid code (e.g., grid code 137A) is available for V2G to be performed at location L. In response to a determination by the backend system that NO grid code is available for location L, method 1000 can return to step 1035, whereupon V2G for the EV remains disabled at the location L.

At 1050, in response to a determination by the backend system that YES, a grid code is available (at the backend system) for location L, the backend system can obtain the grid code/parameters from the grid code database.

At 1060, EV can confirm receipt of the grid codes from the backend system. In response to a determination (e.g., by CCC 119) that NO, the grid codes have still yet to be received (e.g., a defined period of time has elapsed since request for grid codes was transmitted), method 1000 can advance to step 1065, whereupon EV can send a subsequent request (e.g., including location L) to the backend system for the grid code to be sent again.

At 1060, in response to a determination (e.g., by CCC 119) that the grid codes have been received from the backend system, method 1000 can advance to step 1070, whereupon EV can confirm the grid code comprises the anticipated data/parameters. In an example embodiment, EV can perform a checksum operation. In response to a determination (e.g., by CCC 119) that the grid code/parameters has been incorrectly transmitted/received, method 1000 can return to step 1065 for the grid code/parameters to be resent from the backend system to the EV.

At 1070, in response to a determination (e.g., by CCC 119) that the correct grid code/parameters have been received at the EV, method 1000 can advance to step 1080, whereupon the V2G operation at the EV can be enabled, with V2G subsequently being performed, as previously described. In an embodiment, local V2G setting (e.g., local V2G setting 104A) is set (e.g., by CCC 119) to V2G operation is enabled.

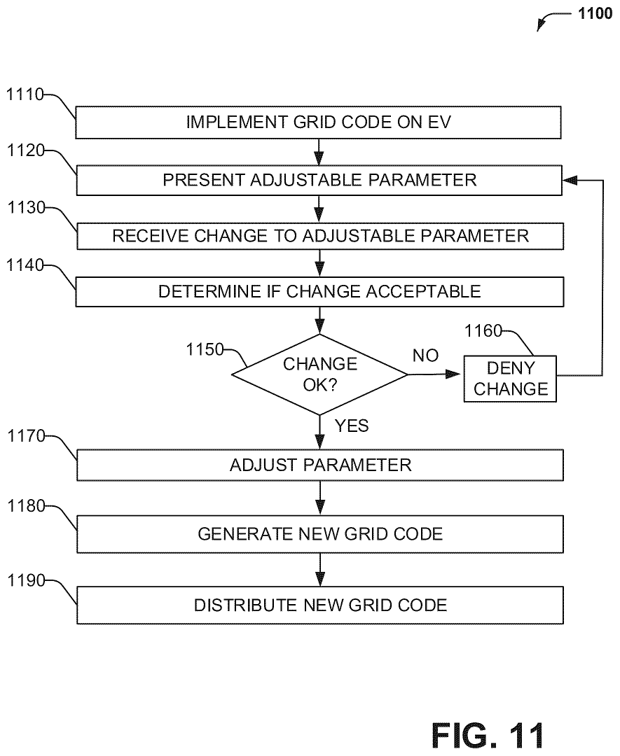

FIG. 11, flowchart 1100 presents a computer-implemented method for confirming and implementing a user change to a grid code, in accordance with at least one embodiment.

At 1110, a first grid code (e.g., grid code 137A) can be configured to be implemented on the EV (e.g., EV 110). In an embodiment, the grid code may have one or more user configurable parameters (e.g., parameters 150A-n), such that while a first portion of the first grid code cannot be adjusted (e.g., comprises parameters/settings that are required to ensure safe operation of the grid 130 and EV 110), a second portion of the first grid code comprises user-configurable settings. However, while the parameters are user-configurable, safety limits may be applicable to prevent a user-configurable parameter from causing unsafe operation of the grid/EV.

At 1120, as previously mentioned, a grid code can be presented to an entity (e.g., user 126A) operating the EV, The first grid code can be presented on a user-interactive HMI/console (e.g., HMI 186A and screens 187A), e.g., located in the EV passenger compartment.

At 1130, a user-implemented change to the parameter can be received and captured at the HMI. A control component (e.g., CCC 119) can be configured to capture the change to the first grid code, the control component is further configured to generate a second grid code from the update to the first grid code, and further save the second grid code (e.g., in memory 184A, grid code database 197).

At 1140, in an embodiment, the control component can be configured to determine whether it is safe/acceptable for the user-implemented change to be applied to the grid code, e.g., based on one or more parameter limits received with first grid code. In another embodiment, the second grid code can be forwarded a remotely located entity, e.g., any of the grid, the DSO, a backend system, etc., (e.g., backend system 126B-n, EVSE 120, grid 130, DSO 138, and suchlike), whereupon the remotely located entity can be configured to determine whether it is safe/acceptable for the user-implemented change to be applied to the grid code, e.g., based on one or more parameter limits received with first grid code (e.g., stored in memory 184B-n of any of backend system 126B-n, EVSE 120, grid 130, DSO 138, and suchlike).

At 1150, in response to a determination (e.g., by CCC 119 or the remotely located system) that NO, the user-implemented change cannot be implemented, method 1100 can advance to step 1160, whereupon the change can be denied (e.g., with a change denied message presented on the HMI 186A) and the first grid code remains implemented at the EV. Method 1100 can return to step 1120.

At 1150, in response to a determination (e.g., by CCC 119 or the remotely located system) that YES, the user-implemented change can be implemented, method 1100 can advance to step 1170, whereupon the change can be implemented with the second grid code implemented on the EV.

At 1180, the second grid code can be configured to replace the first grid code.

At 1190, the second grid code can be distributed to any of the remotely located systems to indicate that the EV is operating with the second grid code, and further the second grid code can be made available to other EVs communicatively coupled to the remotely located system.

### 9. EXAMPLE OPERATING ENVIRONMENT AND SCENARIOS

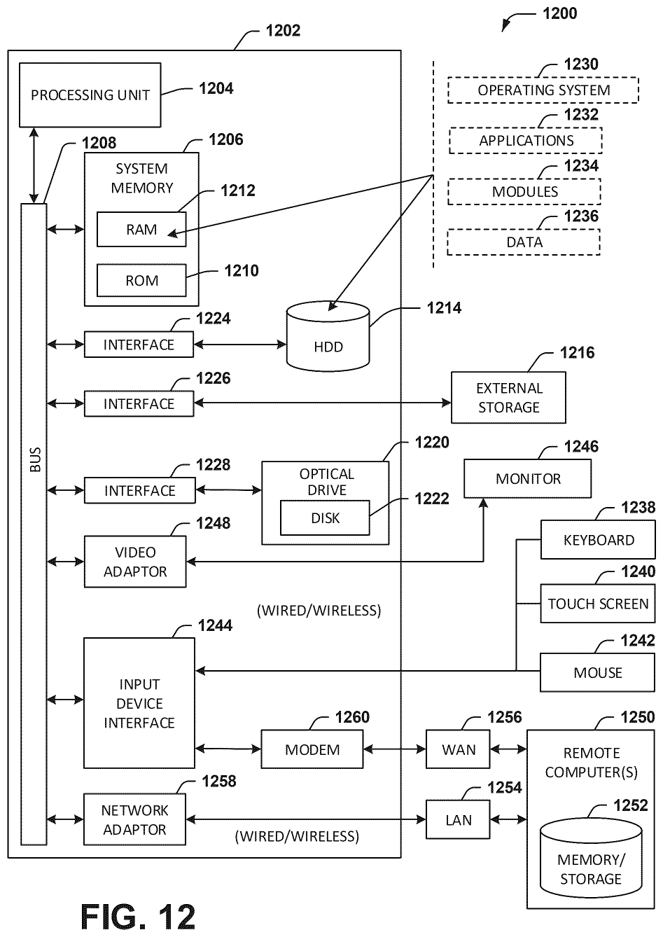

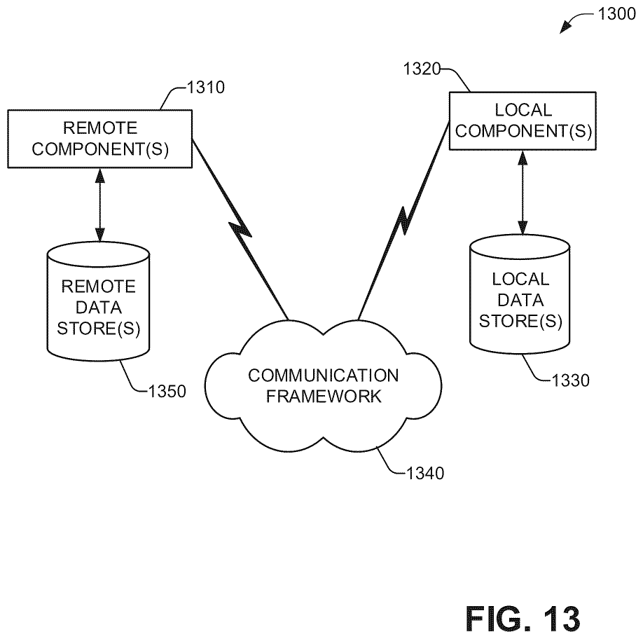

Turning next to FIGS. 12 and 13, a detailed description is provided of additional context for the one or more embodiments described herein with FIGS. 1A-11.

In order to provide additional context for various embodiments described herein, FIG. 12 and the following discussion are intended to provide a brief, general description of a suitable computing environment 1200 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infra-red and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors and may include a cache memory. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid-state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can comprise a security module, such as a trusted processing module (TPM). For instance with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infra-red (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1094 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

Referring now to details of one or more elements illustrated at FIG. 13, an illustrative cloud computing environment 1300 is depicted. FIG. 13 is a schematic block diagram of a computing environment 1300 with which the disclosed subject matter can interact. The system 1300 comprises one or more remote component(s) 1310. The remote component(s) 1310 can be hardware and/or software (e.g., threads, processes, computing devices). In some embodiments, remote component(s) 1310 can be a distributed computer system, connected to a local automatic scaling component and/or programs that use the resources of a distributed computer system, via communication framework 1340. Communication framework 1340 can comprise wired network devices, wireless network devices, mobile devices, wearable devices, radio access network devices, gateway devices, femtocell devices, servers, etc.

The system 1300 also comprises one or more local component(s) 1320. The local component(s) 1320 can be hardware and/or software (e.g., threads, processes, computing devices). In some embodiments, local component(s) 1320 can comprise an automatic scaling component and/or programs that communicate/use the remote resources 1310 and 1320, etc., connected to a remotely located distributed computing system via communication framework 1340.

One possible communication between a remote component(s) 1310 and a local component(s) 1320 can be in the form of a data packet adapted to be transmitted between two or more computer processes. Another possible communication between a remote component(s) 1310 and a local component(s) 1320 can be in the form of circuit-switched data adapted to be transmitted between two or more computer processes in radio time slots. The system 1300 comprises a communication framework 1340 that can be employed to facilitate communications between the remote component(s) 1310 and the local component(s) 1320, and can comprise an air interface, e.g., Uu interface of a UMTS network, via a long-term evolution (LTE) network, etc. Remote component(s) 1310 can be operably connected to one or more remote data store(s) 1350, such as a hard drive, solid state drive, SIM card, device memory, etc., that can be employed to store information on the remote component(s) 1310 side of communication framework 1340. Similarly, local component(s) 1320 can be operably connected to one or more local data store(s) 1330, that can be employed to store information on the local component(s) 1320 side of communication framework 1340.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Various non-limiting aspects of various embodiments described herein are presented in the following clauses.
Clause 1: A system, located onboard an electric vehicle (EV), comprising: a memory that stores computer executable components; and a processor that executes the computer executable components stored in the memory, wherein the computer executable components comprise: a control component configured to: receive an instruction indicating whether a vehicle to grid (V2G) operation can be performed at the EV, wherein the EV has an initial operating condition of V2G operation is disabled, the instruction is received from an external system remotely located to the EV; process the instruction to determine whether the instruction enables or disables V2G operation; and in the event of determining the instruction indicates that V2G operation is enabled, adjust the operating condition to V2G is enabled, thereby enabling the EV to function as a power source for an energy grid.
Clause 2: The system of any preceding clause, wherein the control component is further configured to, in response to determining the instruction does not enable V2G operation, maintain the operating condition as V2G disabled, thereby preventing the EV to function as a power source for the energy grid.
Clause 3: The system of any preceding clause, further comprising one or more onboard batteries located on the EV, wherein the one or more onboard batteries are configured to function as the power source for the energy grid.
Clause 4: The system of any preceding clause, further comprising a location component, configured to: determine a current location of the EV.
Clause 5: The system of any preceding clause, wherein the location component is configured to determine the current location of the EV based on at least one of global positioning system (GPS) location data or location information provided by electric vehicle supply equipment (EVSE) to which the EV is connected to enable connection of the EV to the energy grid.
Clause 6: The system of any preceding clause, wherein the instruction further includes a first grid code to be implemented at the current location by the EV during the V2G operation.
Clause 7: The system of any preceding clause, further comprising an onboard charger connected to one or more batteries located on the EV, wherein the control component is further configured to: generate a second grid code, wherein the second grid code is a copy of the first grid code; and implement the second grid code on the onboard charger to facilitate operation of the one or more batteries in accordance with an operational requirement of the energy grid.
Clause 8: The system of any preceding clause, wherein, prior to implementation of the second grid code on the onboard charger, the control component is further configured to: confirm the first grid code received from the external system matches the second grid code to be implemented at the onboard charger; and in response to a determination that the second grid code does not match the first grid code, the control component is further configured to cancel implementation of the second grid code on the onboard charger.
Clause 9: The system of any preceding clause, wherein the first grid code complies with at least one of a specification or regulation implemented at the grid to ensure safe operation of the energy grid.
Clause 10: The system of any preceding clause, wherein the external system is one of a centralized system controlling at least one operation of the EV, a cloud-based system controlling at least one operation of the EV, or a remote system operated by an original equipment manufacturer (OEM) of the EV.
Clause 11: A computer-implemented method, comprising: receiving, by an onboard device comprising a processor, an instruction indicating whether a vehicle to grid (V2G) operation can be performed at the EV, wherein the EV has an initial operating condition of V2G operation is disabled, the instruction is received from an external system remotely located to the EV; and in response to determining the instruction enables V2G operation, adjusting, by the onboard device, the operating condition to V2G is enabled, thereby enabling the EV to function as a power source for an energy grid.
Clause 12: The computer-implemented method of any preceding clause, further comprising: in response to determining the instruction does not enable V2G operation, maintaining, by the onboard device, the operating condition as V2G disabled, thereby preventing the EV to function as a power source for the energy grid.
Clause 13: The computer-implemented method of any preceding clause, further comprising: identifying, by the onboard device, a location of the EV; transmitting, by the onboard device, the location of the EV to the remotely located system; receiving, by the onboard device, a grid code configured for the location of the EV, wherein the grid code is received from the remotely located system; and implementing, by the onboard device, the grid code to control V2G operation of the EV.
Clause 14: The computer-implemented method of any preceding clause, further comprising: receiving, by the onboard device, an adjustment to the grid code, wherein the adjustment is applied at the EV; transmitting, by the onboard device, the adjustment to the remotely located system; receiving, by the onboard device, an instruction from the remotely located system; determining, by the onboard device, whether the instruction denies implementation of the adjustment to the grid code; and in response to determining the instruction denies implementation of the adjustment to the grid code, preventing, by the onboard device, adjustment of the grid code.
Clause 15: The computer-implemented method of any preceding clause, wherein the external system is one of a centralized system controlling at least one operation of the EV, a cloud-based system controlling at least one operation of the EV, or a remote system operated by an original equipment manufacturer (OEM) of the EV.
Clause 16: The computer-implemented method of any preceding clause, wherein the EV is located at a first location, the method further comprising: terminating, by the onboard device, V2G operation of the EV at the first location; identifying, by the onboard device, a second location of the EV; transmitting, by the onboard device, the second location of the EV to the remotely located system; receiving, by the onboard device, a second grid code configured for the second location of the EV, wherein the second grid code is received from the remotely located system; and implementing, by the onboard device, the second grid code to control V2G operation of the EV at the second location.
Clause 17: A computer program product stored on a non-transitory computer-readable medium and comprising machine-executable instructions, wherein, in response to being executed, the machine-executable instructions cause computing equipment to perform operations, comprising: receiving an instruction indicating whether a vehicle to grid (V2G) operation can be performed at the EV, wherein the EV has an initial operating condition of V2G operation is disabled, the instruction is received from an external system remotely located to the EV; and in response to determining the instruction enables V2G operation, adjusting the operating condition to V2G is enabled, thereby enabling the EV to function as a power source for an energy grid.
Clause 18: The computer program product of any preceding clause, the operations further comprising: identifying a location of the EV; transmitting the location of the EV to the remotely located system; receiving, from the remotely located system, a grid code configured for the location of the EV; and implementing the grid code to control V2G operation of the EV.
Clause 19: The computer program product of any preceding clause, wherein the EV is located at a first location, the operations further comprising, the method further comprising: terminating V2G operation of the EV at the first location; identifying a second location of the EV; transmitting the second location of the EV to the remotely located system; receiving a second grid code configured for the second location of the EV, wherein the second grid code is received from the remotely located system; and implementing the second grid code to control V2G operation of the EV at the second location.
Clause 20: The computer program product of any preceding clause, wherein the external system is one of a centralized system controlling at least one operation of the EV, a cloud-based system controlling at least one operation of the EV, or a remote system operated by an original equipment manufacturer (OEM) of the EV.

In various cases, any suitable combination of clauses 1-10 can be implemented.

In various cases, any suitable combination of clauses 11-16 can be implemented.

In various cases, any suitable combination of clauses 17-20 can be implemented.

What is claimed is:

1. A system, located onboard an electric vehicle (EV), comprising:
a memory that stores computer executable components; and
a processor that executes the computer executable components stored in the memory, wherein the computer executable components comprise:
a control component configured to:
receive an instruction indicating whether a vehicle to grid (V2G) operation can be performed at the EV, wherein the EV has an initial operating condition of V2G operation is disabled, the instruction is received from an external system remotely located to the EV;
process the instruction to determine whether the instruction enables or disables V2G operation; and
in the event of determining the instruction indicates that V2G operation is enabled, adjust the operating condition to V2G is enabled, thereby enabling the EV to function as a power source for an energy grid.

2. The system of claim 1, wherein the control component is further configured to, in response to determining the instruction does not enable V2G operation, maintain the operating condition as V2G disabled, thereby preventing the EV to function as a power source for the energy grid.

3. The system of claim 1, further comprising one or more onboard batteries located on the EV, wherein the one or more onboard batteries are configured to function as the power source for the energy grid.

4. The system of claim 1, further comprising a location component, configured to:
determine a current location of the EV.

5. The system of claim 4, wherein the location component is configured to determine the current location of the EV based on at least one of global positioning system (GPS) location data or location information provided by electric vehicle supply equipment (EVSE) to which the EV is connected to enable connection of the EV to the energy grid.

6. The system of claim 5, wherein the instruction further includes a first grid code to be implemented at the current location by the EV during the V2G operation.

7. The system of claim 6, further comprising an onboard charger connected to one or more batteries located on the EV, wherein the control component is further configured to:
generate a second grid code, wherein the second grid code is a copy of the first grid code; and
implement the second grid code on the onboard charger to facilitate operation of the one or more batteries in accordance with an operational requirement of the energy grid.

8. The system of claim 7, wherein, prior to implementation of the second grid code on the onboard charger, the control component is further configured to:
confirm the first grid code received from the external system matches the second grid code to be implemented at the onboard charger; and
in response to a determination that the second grid code does not match the first grid code, the control component is further configured to cancel implementation of the second grid code on the onboard charger.

9. The system of claim 6, wherein the first grid code complies with at least one of a specification or regulation implemented at the grid to ensure safe operation of the energy grid.

10. The system of claim 1, wherein the external system is one of a centralized system controlling at least one operation of the EV, a cloud-based system controlling at least one operation of the EV, or a remote system operated by an original equipment manufacturer (OEM) of the EV.

11. A computer-implemented method, comprising:
receiving, by an onboard device comprising a processor, an instruction indicating whether a vehicle to grid (V2G) operation can be performed at the EV, wherein the EV has an initial operating condition of V2G operation is disabled, the instruction is received from an external system remotely located to the EV; and
in response to determining the instruction enables V2G operation, adjusting, by the onboard device, the operating condition to V2G is enabled, thereby enabling the EV to function as a power source for an energy grid.

12. The computer-implemented method of claim 11, further comprising:
in response to determining the instruction does not enable V2G operation, maintaining, by the onboard device, the operating condition as V2G disabled, thereby preventing the EV to function as a power source for the energy grid.

13. The computer-implemented method of claim 11, further comprising:
identifying, by the onboard device, a location of the EV;
transmitting, by the onboard device, the location of the EV to the remotely located system;
receiving, by the onboard device, a grid code configured for the location of the EV, wherein the grid code is received from the remotely located system; and
implementing, by the onboard device, the grid code to control V2G operation of the EV.

14. The computer-implemented method of claim 11, further comprising:
receiving, by the onboard device, an adjustment to the grid code, wherein the adjustment is applied at the EV;
transmitting, by the onboard device, the adjustment to the remotely located system;
receiving, by the onboard device, an instruction from the remotely located system;
determining, by the onboard device, whether the instruction denies implementation of the adjustment to the grid code; and
in response to determining the instruction denies implementation of the adjustment to the grid code, preventing, by the onboard device, adjustment of the grid code.

15. The computer-implemented method of claim 11, wherein the external system is one of a centralized system controlling at least one operation of the EV, a cloud-based system controlling at least one operation of the EV, or a remote system operated by an original equipment manufacturer (OEM) of the EV.

16. The computer-implemented method of claim 11, wherein the EV is located at a first location, the method further comprising:
terminating, by the onboard device, V2G operation of the EV at the first location;
identifying, by the onboard device, a second location of the EV;
transmitting, by the onboard device, the second location of the EV to the remotely located system;
receiving, by the onboard device, a second grid code configured for the second location of the EV, wherein the second grid code is received from the remotely located system; and
implementing, by the onboard device, the second grid code to control V2G operation of the EV at the second location.

17. A computer program product stored on a non-transitory computer-readable medium and comprising machine-executable instructions, wherein, in response to being executed, the machine-executable instructions cause computing equipment to perform operations, comprising:
receiving an instruction indicating whether a vehicle to grid (V2G) operation can be performed at the EV, wherein the EV has an initial operating condition of V2G operation is disabled, the instruction is received from an external system remotely located to the EV; and
in response to determining the instruction enables V2G operation, adjusting the operating condition to V2G is enabled, thereby enabling the EV to function as a power source for an energy grid.

18. The computer program product according to claim 17, the operations further comprising:
identifying a location of the EV;
transmitting the location of the EV to the remotely located system;
receiving, from the remotely located system, a grid code configured for the location of the EV; and
implementing the grid code to control V2G operation of the EV.

19. The computer program product according to claim 18, wherein the EV is located at a first location, the operations further comprising, the method further comprising:
terminating V2G operation of the EV at the first location;
identifying a second location of the EV;
transmitting the second location of the EV to the remotely located system;
receiving a second grid code configured for the second location of the EV, wherein the second grid code is received from the remotely located system; and
implementing the second grid code to control V2G operation of the EV at the second location.

20. The computer program product according to claim 17, wherein the external system is one of a centralized system controlling at least one operation of the EV, a cloud-based system controlling at least one operation of the EV, or a remote system operated by an original equipment manufacturer (OEM) of the EV.
